(19) United States
(12) Patent Application Publication
(10) Pub. No.: US 2016/0098652 A1
(43) Pub. Date: Apr. 7, 2016

(54) Method and system for the management and evaluation of potential events

(71) Applicant: Neil Raymond Leigh, Netanya (IL)

(72) Inventor: Neil Raymond Leigh, Netanya (IL)

(21) Appl. No.: 14/505,540

(22) Filed: Oct. 3, 2014

(51) Int. Cl. G06Q 10/06

(52) U.S. Cl. CPC G06Q 10/0635

(57) ABSTRACT

A system, apparatus or product for the management and evaluation of potential events. The method comprising: obtaining potential event specifications and obtaining control specifications defining controls. A potential event specification defines an initial evaluation of a potential event and an effect of different evaluations of the potential event on the evaluation of one or more other potential events. A control specification defines potential findings for a control. The control specification defines for each potential finding an effect on an evaluation of one or more potential events. The method further comprises obtaining findings of performing monitoring of the controls, and determining a modified evaluation for each potential event as a modification of the initial evaluation of the potential event. The modified evaluation is based on an aggregated effect of findings and of other potential events on the potential event, in accordance with the potential event specification and the control specification.

### TECHNICAL FIELD

The present disclosure relates to information technology in general, and to management control systems and risk management systems, in particular.

### BACKGROUND

A number of approaches have been published for improving the state of an organization, including management control systems, objective-oriented management philosophies, internal control, risk management, standards and ‘best practices’. These approaches are elaborated below.

A management control system (MCS) is meant to give managers the ability to ‘steer’ their organization towards achieving their strategies and objectives, through insight into the internal performance of their organizational processes. Management control systems use many different techniques, such as balanced scorecards, budgeting and management techniques. Furthermore, management control systems published to date lack the detailed processes of acquiring the appropriate management information required for improved management decision making and control of the organization.

Objective-oriented management philosophies set objectives towards which the organization is geared. An example is Management by Objectives (MBO)—which is intended to build motivation and involvement in workers by setting clear objectives. This is largely a policy approach.

The professional internal control community has given rise to the publication of several structured guidelines called internal control frameworks. Such frameworks are written guidelines and best practices and do not incorporate technological tools for their implementation. Their implementation is done in a largely manual manner with the help of professional service providers. Internal control frameworks do not specify a qualitative or quantitative indication of how the organization's internal performance affects its objectives. A number of internal control frameworks have been published and these include: The Committee of Sponsoring Organizations of the Treadway Commission (COSO) Integrated Framework, Control Objectives for Information and Related Technology (COBIT), The Turnbull Guidance and Criteria of Control Board Guidance on Control (CoCo). All of these are recommended guidelines and the organizations that choose to adopt them, adapt them to fit their own constraints and understanding.

Risk management is a commonly used term and has given rise to various proprietary risk management systems implemented in software. The primary focus of such systems is demonstrating risk management activity to senior management and authorities, reduction of risk in the organization and ensuring financial robustness. Risk management systems are designed to assess and document risks; however, they lack the entities and the processes needed for management control. The same may be said also of Enterprise Risk Management (ERM), which constitutes a more defined business strategy than just ‘risk management’. However, like internal control frameworks, these are guidelines, not implementations. Examples are: RIMS (Risk maturity model) and The COSO ERM Framework.

Standards and best practices. International Organization for Standardization (ISO), such as ISO 31000, Total Quality Management (TQM) and the like are further methodologies sharing similar aims but again, without a definitive metric for assessing them.

### BRIEF SUMMARY

One exemplary embodiment of the disclosed subject matter is a computerized apparatus comprising: a processor, wherein the processor is adapted to perform the steps of: obtaining potential event specifications defining potential events, wherein a potential event has an evaluation, wherein a potential event specification defines an initial evaluation of a potential event, wherein the potential event specification further defines an effect of different evaluations of a potential event on an evaluation of one or more other potential events; obtaining control specifications defining controls, wherein a control specification defines potential findings for a control, wherein the control specification defines for each potential finding an effect on an evaluation of one or more potential events; obtaining findings of performing monitoring of the controls defined by the control specifications; determining a modified evaluation for each potential event as a modification of the initial evaluation of the potential event, wherein the modified evaluation is based on an aggregated effect of findings and of other potential events on the potential event, in accordance with the potential event specification and the control specification; and outputting the modified evaluation of the potential events to a user.

Optionally, the evaluation of the potential event comprises a likelihood of the potential event occurring and an impact resulting from the occurrence of the potential event.

Optionally, each finding is associated with at least one resource which was monitored as part of the monitoring of the control; wherein the processor is further adapted to perform: obtaining a set of selected one or more resources; wherein determining the modified evaluation for each potential event comprises filtering the findings to the findings that are associated with the set of selected one or more resources; and determining the modified evaluation based on the filtered set of findings and disregarding other findings that are not associated with the set of one or more resources.

Optionally, the resources are components that participate in monitoring of the controls, wherein the resources are selected from the group consisting of: people and forms.

Optionally, the processor is further adapted to: obtain definitions associating resources with one or more organizational units, wherein obtaining the set of selected one or more resources comprises obtaining a selected organizational unit and determining, based on the definitions, the resources that are associated with the selected organizational unit.

Optionally, determining the modified evaluation comprises: computing a first effect of an evaluation of a first finding on the potential event; computing a second effect of an evaluation of a second finding on the potential event; aggregating the first and second effect using an aggregated function, wherein the aggregated function is selected from the group consisting of: a minimum function, a maximum function, a weighted average function, a median function, a summation function, a summation function with a diminishing marginal effect, and a combination thereof.

Optionally, determining the modified evaluation comprises: computing a first effect of an evaluation of a first other potential event on the potential event; computing a second effect of an evaluation of a second other potential event on the potential event; aggregating the first and second effect using an aggregated function, wherein the aggregated function is selected from the group consisting of: a minimum function, a maximum function, a weighted average function, a median function, a summation function, a summation function with a diminishing marginal effect, and a combination thereof.

Optionally, the processor is further adapted to perform: identifying potential events whose evaluations are not affected, directly or indirectly, by any of the findings; and alerting the user of the identified potential events.

Optionally, the monitoring of the controls is performed manually, and wherein obtaining the findings comprises receiving reports of the performing the monitoring of the controls.

Optionally, the monitoring of the controls is performed automatically by a computer, and wherein obtaining the findings comprises receiving the findings in a computer-readable format.

Optionally, the potential event is selected from a group consisting of: a goal, an aim, an objective, a risk, an opportunity, a desired state, an undesired state, a desired event and an undesired event.

Optionally, the processor is further adapted to perform: obtaining scheduling specifications defining scheduling of control monitoring, wherein a scheduling specification defines a time on which controls should be monitored; identifying a missed monitoring of a control based on the scheduling specification and the findings; and notifying the user of the missed monitoring of the control.

Optionally, said control specification further defines for each potential finding an evaluated quality score, wherein evaluated quality score comprises an assessment of a performance resulting in an occurrence of the potential finding.

Optionally, the processor is further adapted to perform: computing an aggregated quality score, wherein said computing the aggregated quality score comprises: obtaining an aggregation criterion; aggregating all findings falling within the aggregation criterion using an aggregation function, wherein the aggregation function is selected from the group consisting of: a minimum function, a maximum function, a weighted average function, a median function, a summation function, a summation function with a diminishing marginal effect, and a combination thereof; and displaying the aggregated quality score to a user.

Another exemplary embodiment of the disclosed subject matter is a method comprising obtaining potential event specifications defining potential events, wherein a potential event has an evaluation, wherein a potential event specification defines an initial evaluation of a potential event, wherein the potential event specification further defines an effect of different evaluations of a potential event on an evaluation of one or more other potential events; obtaining control specifications defining controls, wherein a control specification defines potential findings for a control, wherein the control specification defines for each potential finding an effect on an evaluation of one or more potential events; obtaining findings of performing monitoring of the controls defined by the control specifications; determining, by a processor, a modified evaluation for each potential event as a modification of the initial evaluation of the potential event, wherein the modified evaluation is based on an aggregated effect of findings and of other potential events on the potential event, in accordance with the potential event specification and the control specification; and outputting the modified evaluation of the potential events to a user.

Yet another exemplary embodiment of the disclosed subject matter is a computer program product comprising a computer readable storage medium retaining program instructions, which program instructions when read by a processor, cause the processor to perform a method comprising obtaining potential event specifications defining potential events, wherein a potential event has an evaluation, wherein a potential event specification defines an initial evaluation of a potential event, wherein the potential event specification further defines an effect of different evaluations of a potential event on an evaluation of one or more other potential events; obtaining control specifications defining controls, wherein a control specification defines potential findings for a control, wherein the control specification defines for each potential finding an effect on an evaluation of one or more potential events; obtaining findings of performing monitoring of the controls defined by the control specifications: determining a modified evaluation for each potential event as a modification of the initial evaluation of the potential event, wherein the modified evaluation is based on an aggregated effect of findings and of other potential events on the potential event, in accordance with the potential event specification and the control specification; and outputting the modified evaluation of the potential events to a user.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a flowchart illustrating components of a system for the management and evaluation of potential events according to an embodiment of the disclosed subject matter, FIG. 2 is a flowchart illustrating steps of configuring potential events, according to an embodiment of the disclosed subject matter;

FIG. 3 is a flowchart illustrating steps of scheduling control activity, according to an embodiment of the disclosed subject matter;

FIG. 4 is a flowchart illustrating steps of managing findings from control monitoring activity, according to an embodiment of the disclosed subject matter;

FIG. 5 is a flowchart illustrating a method of modifying likelihood of potential events, using aggregation, in accordance with some embodiments of the disclosed subject matter;

FIG. 6 is a flowchart illustrating a method for computing aggregated findings data for a control, in accordance with some embodiments of the disclosed subject matter;

FIG. 7 is a flowchart illustrating a method for calculating an aggregated likelihood effect for a potential event, in accordance with some embodiments of the disclosed subject matter;

FIG. 8 is a flowchart illustrating an exemplary embodiment of a method for calculating a modified likelihood for a potential event, based on its controls, in accordance with some embodiments of the disclosed subject matter;

FIG. 9 is a flowchart illustrating an exemplary embodiment of a method for calculating a modified likelihood for a potential event, based on other potential events, in accordance with some embodiments of the disclosed subject matter;

FIG. 10 is an illustration of a configuration of data elements, in accordance with some embodiments of the disclosed subject matter;

FIG. 11 is an entity relation diagram illustrating data elements involved in calculating a modified likelihood for a potential event, in accordance with some embodiments of the disclosed subject matter;

FIG. 12 is a table illustrating potential events and their evaluation likelihood, in accordance with some embodiments of the disclosed subject matter;

FIG. 13 is a table illustrating evaluation likelihood effects of potential events on other potential events, in accordance with some embodiments of the disclosed subject matter;

FIG. 14 is a table illustrating findings and the likelihood effect of each finding on the potential event, in accordance with some embodiments of the disclosed subject matter;

FIG. 15 is a flowchart illustrating steps and resulting computed values of an example calculation of modified likelihood for a potential event, in accordance with some embodiments of the disclosed subject matter;

FIG. 16 is a flowchart of a process for notifying users of upcoming control monitoring tasks, in accordance with some embodiments of the disclosed subject matter;

FIG. 17 is a flowchart of a process for notifying users of uncompleted control monitoring tasks, in accordance with some embodiments of the disclosed subject matter;

FIG. 18 is a flowchart of a potential event history report, in accordance with some embodiments of the disclosed subject matter;

FIG. 19 is a flowchart of a findings report, in accordance with some embodiments of the disclosed subject matter;

FIG. 20 is a flowchart of an algorithm for reporting potential events without controls, in accordance with some embodiments of the disclosed subject matter;

FIG. 21 is an external I/O diagram, in accordance with some embodiments of the disclosed subject matter;

FIG. 22 is a mockup of a screen for configuring organizational structure, in accordance with some embodiments of the disclosed subject matter;

FIG. 23 is a mockup of a screen for configuring resources and resource groups, in accordance with some embodiments of the disclosed subject matter;

FIG. 24 is a mockup of a screen for configuring potential events, in accordance with some embodiments of the disclosed subject matter;

FIG. 25 is a mockup of a screen for configuring controls, in accordance with some embodiments of the disclosed subject matter;

FIG. 26 is a mockup of a screen for defining a schedule, in accordance with some embodiments of the disclosed subject matter;

FIG. 27 is a mockup of a screen for selecting a schedule, as a preliminary step before entering findings, in accordance with some embodiments of the disclosed subject matter;

FIG. 28 is a mockup of a screen for selecting a control, as a preliminary step before entering findings, in accordance with some embodiments of the disclosed subject matter;

FIG. 29 is a mockup of a screen displaying findings entered previously in the system, in accordance with some embodiments of the disclosed subject matter;

FIG. 30 is a mockup of a screen for entering findings, in accordance with some embodiments of the disclosed subject matter;

FIG. 31 is a mockup of a potential event history report, in accordance with some embodiments of the disclosed subject matter;

FIG. 32 is a mockup of a findings report, in accordance with some embodiments of the disclosed subject matter;

FIG. 33 is a flowchart of a potential event status report, in accordance with some embodiments of the disclosed subject matter;

FIG. 34 is a mockup of a potential event status report, in accordance with some embodiments of the disclosed subject matter;

FIG. 35 is a flowchart illustrating a method for calculating performance, based on aggregation of controls, in accordance with some embodiments of the disclosed subject matter;

FIG. 36 is a flowchart illustrating a method for calculating performance, based on aggregation of findings, in accordance with some embodiments of the disclosed subject matter; and

FIG. 37 is a mockup of a performance report based on the aggregation of controls, in accordance with some embodiments of the disclosed subject matter.

### DETAILED DESCRIPTION OF THE DRAWINGS

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

The methodologies and approaches described in the background section place importance on the achievement of objectives, yet fail to provide a system, method or product for assessing the degree of achievement attained of those objectives at a certain point in time. The disclosed subject matter may address the current lack of unambiguous assessment of objectives, risks and other strategic aims, and may establish a method, system and product for managing and evaluating potential events, including objectives, risks, opportunities and others.

In the present disclosure, a ‘potential event’ is an event that has the potential of occurring. The occurrence of the event may have significance to an organization. Potential event could be: a goal, an aim, a risk, an opportunity, a desired state, an undesired state, a desired event, an undesired event, or the like. Potential events may be affected by other potential events. In some cases, potential events are evaluated by a user who makes an evaluation and then assigns the results of the evaluation to the potential event. These results may be termed ‘evaluation data of potential events’ and may include likelihood, impact, likelihood effect of one potential event on another, impact effect of one potential event on another, acceptable likelihood and acceptable impact.

In the present disclosure, likelihood is a sequence of values consisting of a text description and a sequential numerical value. In some embodiments, the list of likelihood values might comprise: 1—Unlikely, 2—Some possibility, 3—Fair possibility, 4—Likely, 5—High probability. Other embodiments may employ other sequences. It is noted that likelihood values not defined explicitly may be defined implicitly, for example a likelihood value of 1.5 may be implicitly defined as ‘between 1—Unlikely and 2—Some possibility’.

In the present disclosure, impact is a sequence of values consisting of a text description and a sequential numerical value. In some embodiments, the sequence of impact values might comprise: 1—High negative impact, 2—Medium-high negative impact, 3—Medium negative impact, 4—Low-medium negative impact, 5—Low negative impact, 6, no impact, 7—Low positive impact, 8—Low-medium positive impact, 9—medium positive impact, 10—Medium-high positive impact, 11—High positive impact. It is noted that impact values not defined explicitly may be defined implicitly, for example an impact of 7.5 may be implicitly defined as ‘between 7—Low positive impact and 8—Low-medium positive impact’.

In the present disclosure, likelihood effect is the change that would be effected on the likelihood of a potential event following the occurrence of some event such as a potential finding or other potential event. One example is a likelihood effect of a finding on the likelihood of a potential event, wherein the occurrence of the finding modifies the likelihood of the potential event occurring. Another example is a likelihood effect of one potential event on the likelihood of another, wherein the occurrence of the one potential event modifies the likelihood of the other potential event occurring. In some embodiments, likelihood effect may be a positive or negative numerical value and may have a value of 0. In some embodiments, likelihood effect may be a percentage. In some embodiments, likelihood effect may be a relative or absolute value.

In the present disclosure, impact effect is the change that would be effected on the impact of a potential event following the occurrence of some event such as a potential finding or other potential event. One example is an impact effect of a finding on the impact of a potential event, wherein the occurrence of the finding modifies the impact of the potential event if it occurs. Another example is an impact effect of one potential event on the impact of another, wherein the occurrence of the one potential event modifies the impact of the other potential event if the other potential event occurs. In some embodiments, impact effect may be a positive or negative numerical value and may have a value of 0. In some embodiments, impact effect may be a percentage. In some embodiments, impact effect may be a relative or absolute value.

In the present disclosure, a ‘potential finding is a finding that has the potential of occurring. The occurrence of the finding may have significance to an organization. One or more potential findings may be a part of a control definition. Potential finding could be: a number, a range, a subjective evaluation, an objective evaluation, an assessment, a conclusion or any other kind of impression resulting from an observation of a control. In some cases, potential findings are evaluated by a user who makes an evaluation and then assigns the results of the evaluation to the potential finding. These results may be termed ‘evaluation data of potential findings’ and may include likelihood effect on a potential event, impact effect on a potential event and quality score. When evaluating a control, in a control monitoring activity, a user may determine a suitable finding for the control by selecting a finding from one or more potential findings.

In the present disclosure, an ‘evaluation’ is an assessment made by a user, which is stored in the system as evaluation data, such as evaluation likelihood and evaluation likelihood effect. Evaluation data may subsequently be manually updated but this does not make it a ‘modified evaluation’, which is defined separately forthwith, in accordance with the disclosed subject matter. An evaluation may be made for a potential event. An evaluation may be made for a potential finding. Evaluation of a potential event may refer to the evaluation at the current time and may also be termed ‘initial evaluation’ or ‘current evaluation’.

In the present disclosure, a ‘modified evaluation’ is a calculated value based on evaluation data of a potential event and an aggregated effect from findings. Modified evaluation data may also be termed ‘modified data’, such as modified likelihood, modified likelihood effect, modified impact and modified impact effect.

In the present disclosure, a ‘control’ is a process, procedure, practice, condition, stipulation or requirement that serves to ensure other processes work as intended. Controls can be executed by, on or associated with one or more resources.

In the present disclosure, a ‘Control monitoring’ is the observing of controls that have been or should have been implemented. One or more findings may be obtained, determined or generated based on the monitoring of a control. The findings may be recorded.

In the present disclosure, a ‘resource’ is a component, asset or part of the organization that can be observed, examined or otherwise participate in a control. It may be an entity belonging to or associated with the organization that is involved in a control. Non limiting examples of monitored resources are employees, items of equipment, suppliers, customers, purchase order forms, invoices, rooms, buildings. Non limiting examples of the resource's involvement in a control are the employee who carries out the control, the purchase order form that is being checked in the control, the machine that is being examined in the control. In some embodiments, ‘resource’ may be alternatively termed ‘asset’.

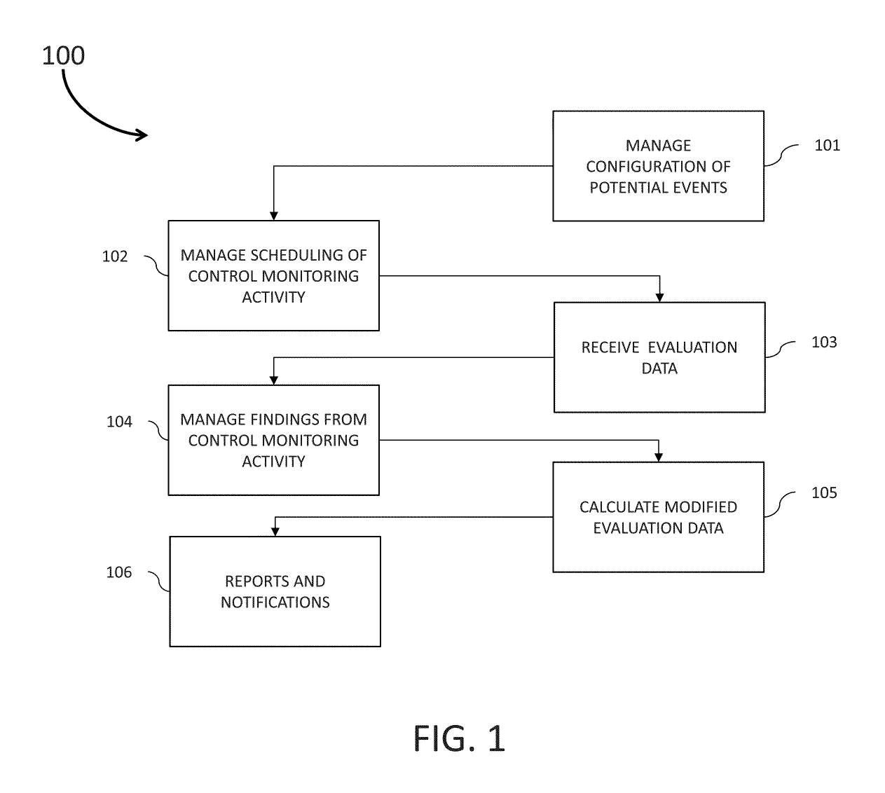

FIG. 1 is a flowchart illustrating components of a system for the management and evaluation of potential events according to an embodiment of the disclosed subject matter. FIG. 1 may depict steps of an operation performed by a computerized apparatus.

Step 101 handles the receiving and organization of data from users, specifying potential events, relationships between potential events, resources, organizational structure, controls and other data in the current embodiment. Step 101 is described in more detail in FIG. 2.

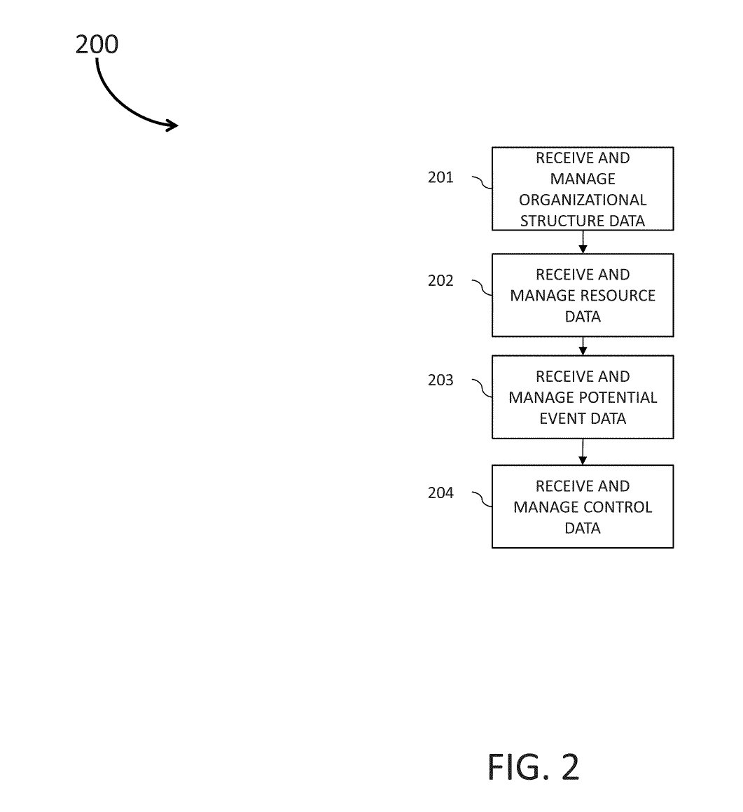

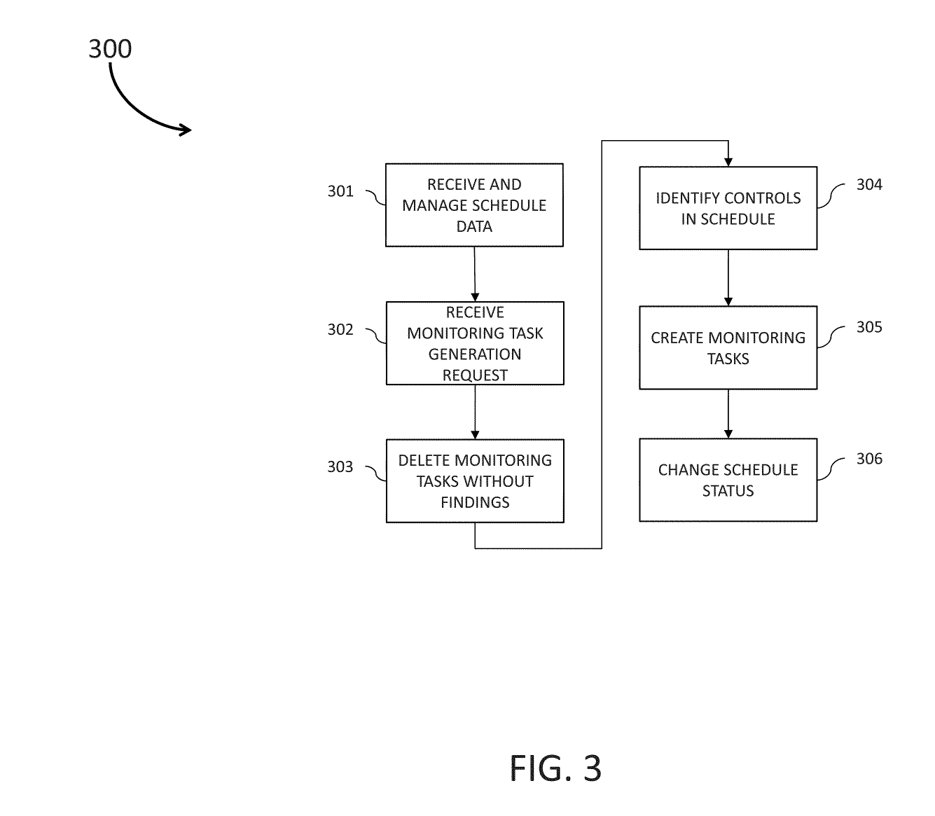

Step 102 handles the receiving of data from users, which defines scheduling of control activity, the result of which will lead to the receiving of findings. Step 102 is described in more detail in FIG. 3.

Step 103 handles the receiving of evaluation data from users, which includes such data as likelihood of potential events, impact of potential events, effect of likelihood of one potential event on another, effect of impact of one potential event on another, likelihood effect of potential findings on potential events, impact effect of potential findings on potential events, quality score of potential findings and other data.

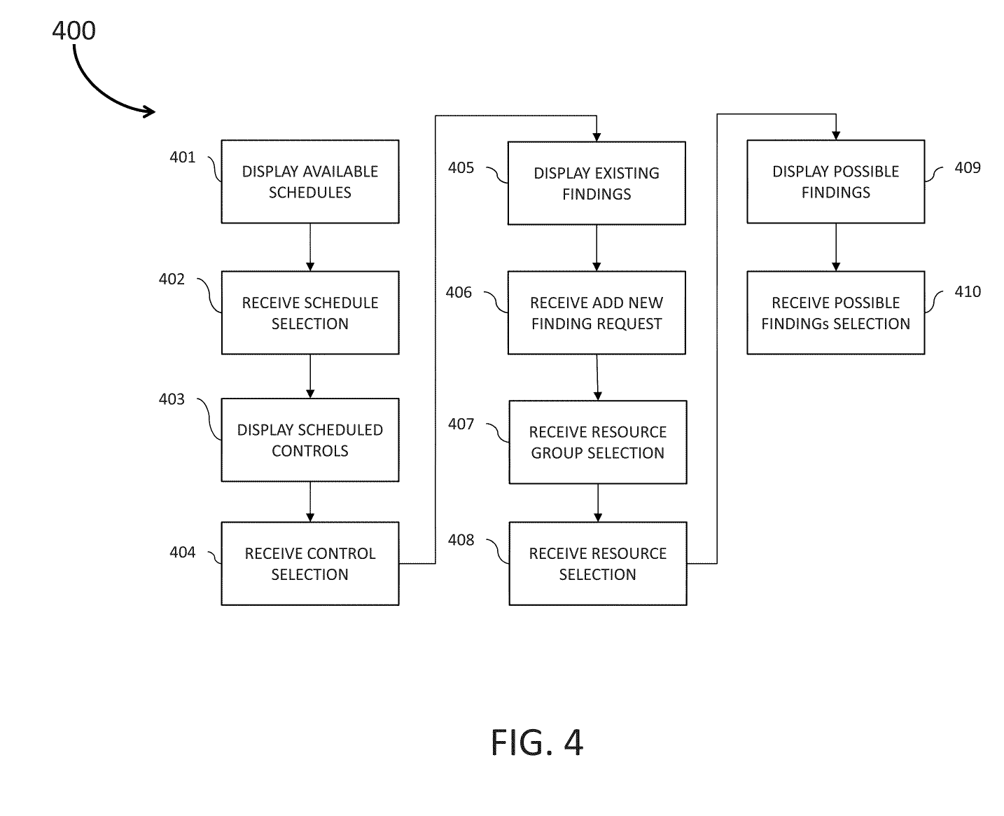

Step 104 handles the receiving of findings data from users, resulting from control activity performed by users. Step 104 is described in more detail in FIG. 4.

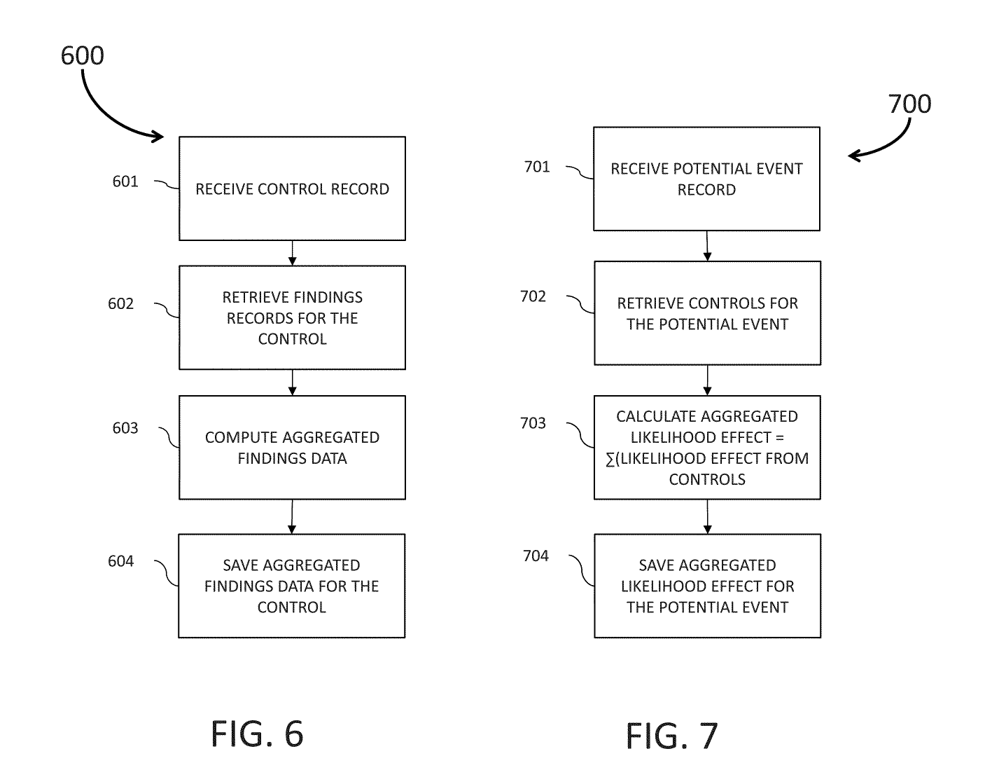

Step 105 is a calculation of a modified evaluation based on evaluation data and the effect of findings. Step 105 is described in more detail in FIGS. 6-15 and other referenced drawings.

It is noted that the sequence of steps depicted is just one possible sequence and all steps may be performed more than one time, for example, after the completion of steps 101-105, further evaluation data may be received in step 103, following, for example a reassessment by a user. Furthermore, it will be noted that data may be obtained directly from the user or indirectly from a computer readable medium that retains information previously provided by the user, such as a digital file, a data storage device, or the like, which may retain data from one session to another.

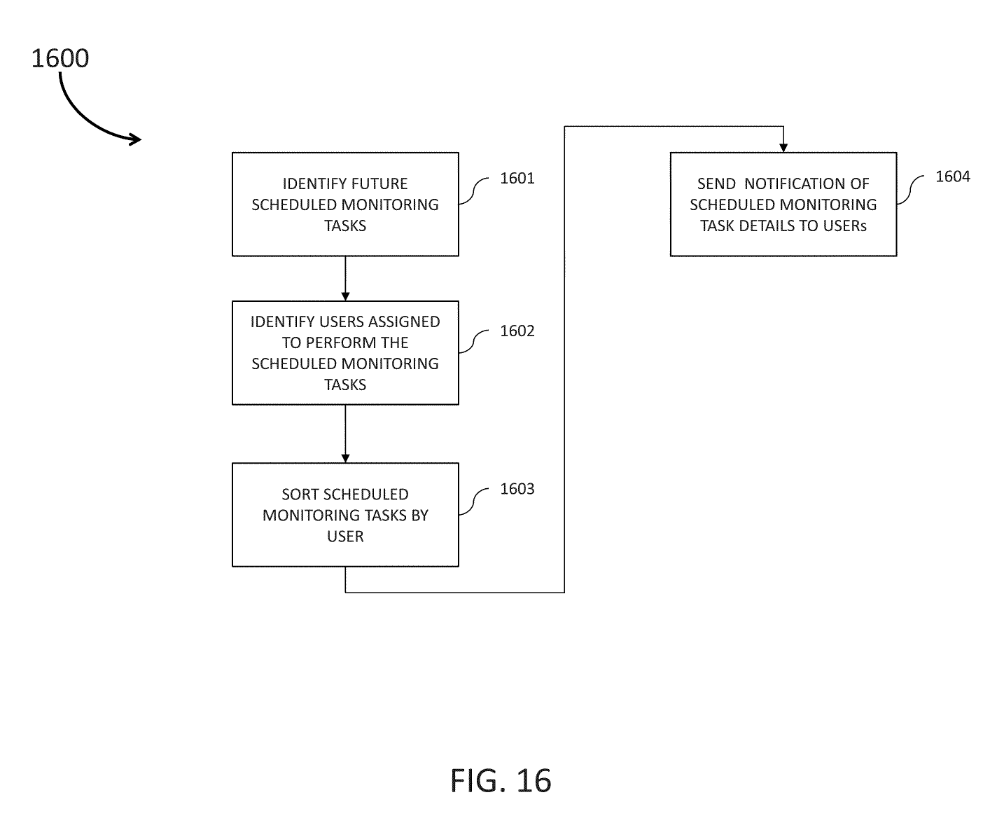

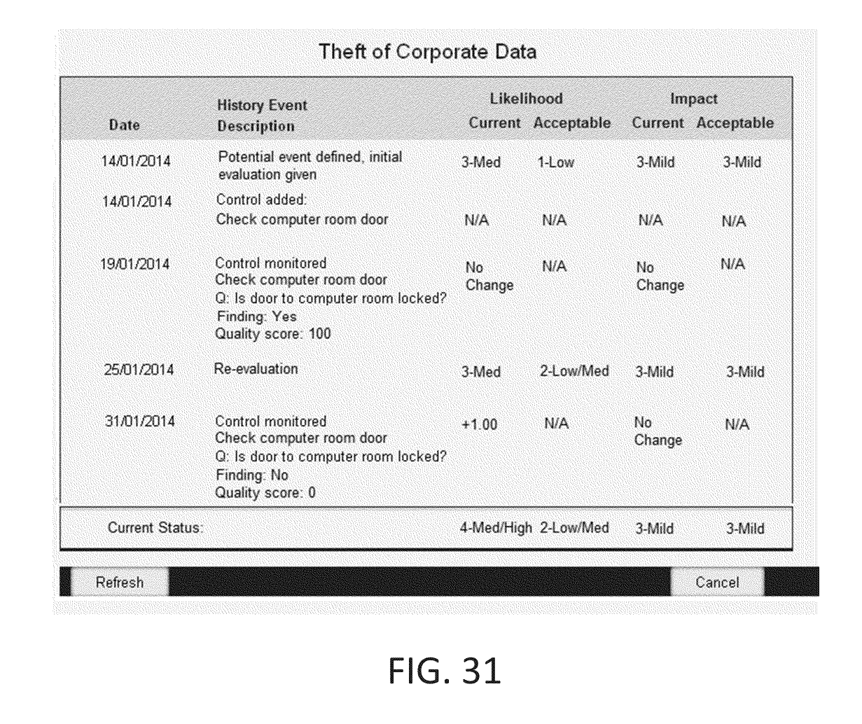

In Step 106 reports or notifications may be produced. A computerized apparatus may output data that has been received and calculated in previous steps, providing a user insight into the state of the organization, including the effects of findings on its performance, notifications and warnings and modified evaluations of objectives, risks and other potential events. Non-limiting example processes of step 106 are given in FIGS. 16, 17, 18, 19, 20, 33, 35 and 36 and non-limiting example reports of step 106 are given in FIGS. 31, 32, 34 and 37.

FIG. 2 is a flowchart illustrating steps of configuring potential events, according to an embodiment of the disclosed subject matter. In some exemplary embodiments, the steps of FIG. 2 may be performed as part of step 101 of FIG. 1.

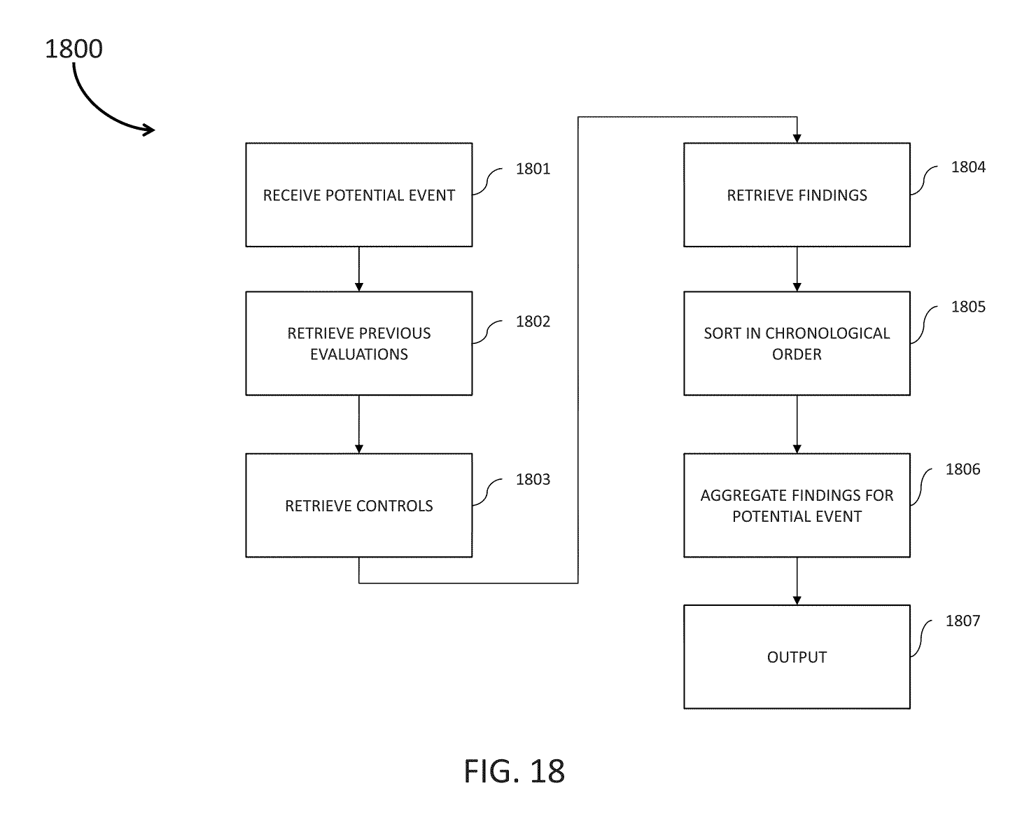

It is noted that all of the subsequent steps—201, 202, 203 and 204—may employ data management functions such as changing and deleting data including logical deletions in which previous data values may be saved for future use, for example in history reports such as depicted in the flowchart of FIG. 18 and report of FIG. 31 and the descriptions herein.

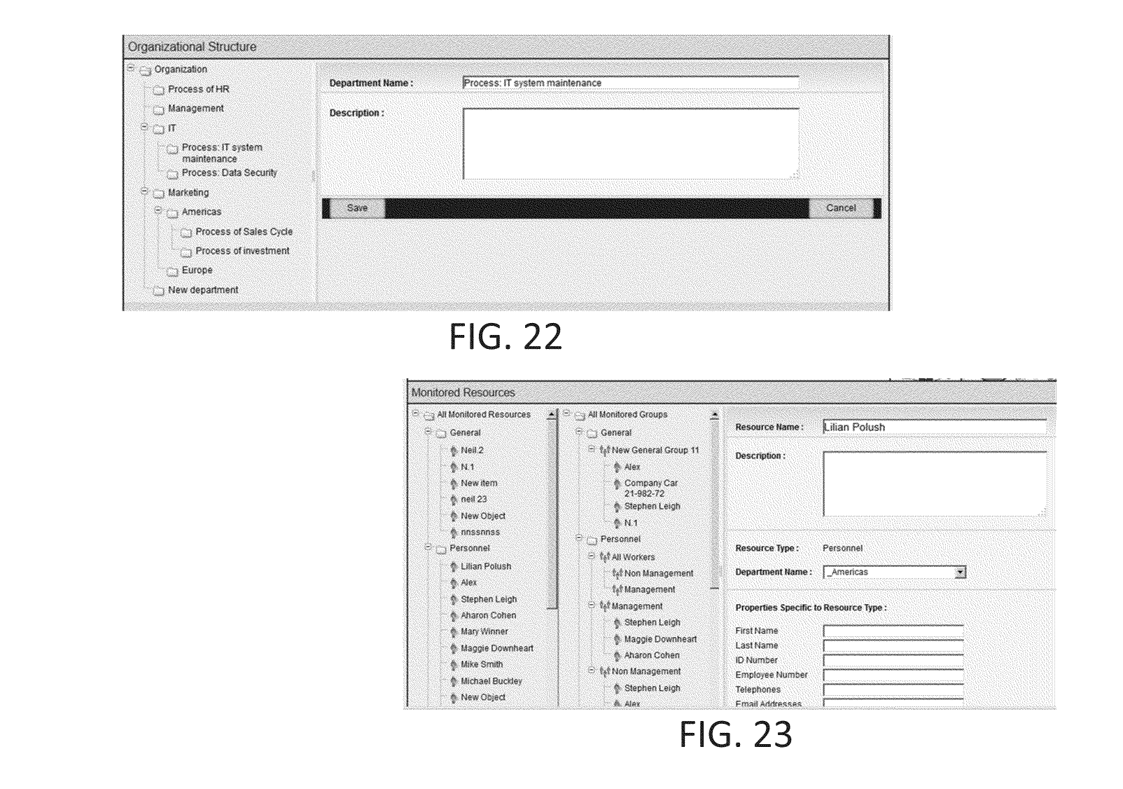

In step 201, the computerized apparatus outputs data on a computerized output device and receives input from a user, specifying an organizational structure consisting of divisions, departments, organizational units and the like. In some cases, hierarchy between sub-units of the organization may be defined. Step 201 may employ data management functions such as adding, changing, deleting and printing data. A mockup of output data configured for this step can be seen in FIG. 22.

In step 202, the computerized apparatus outputs data on a computerized output device and receives input from a user, specifying resources such as but not limited to personnel, equipment, forms, documents and the like. Step 202 may employ data management functions such as adding, changing, deleting and printing data. Resources can be assigned to organizational units defined in step 201. Resources can be grouped into resource groups. A mockup of output data configured for this step can be seen in FIG. 23.

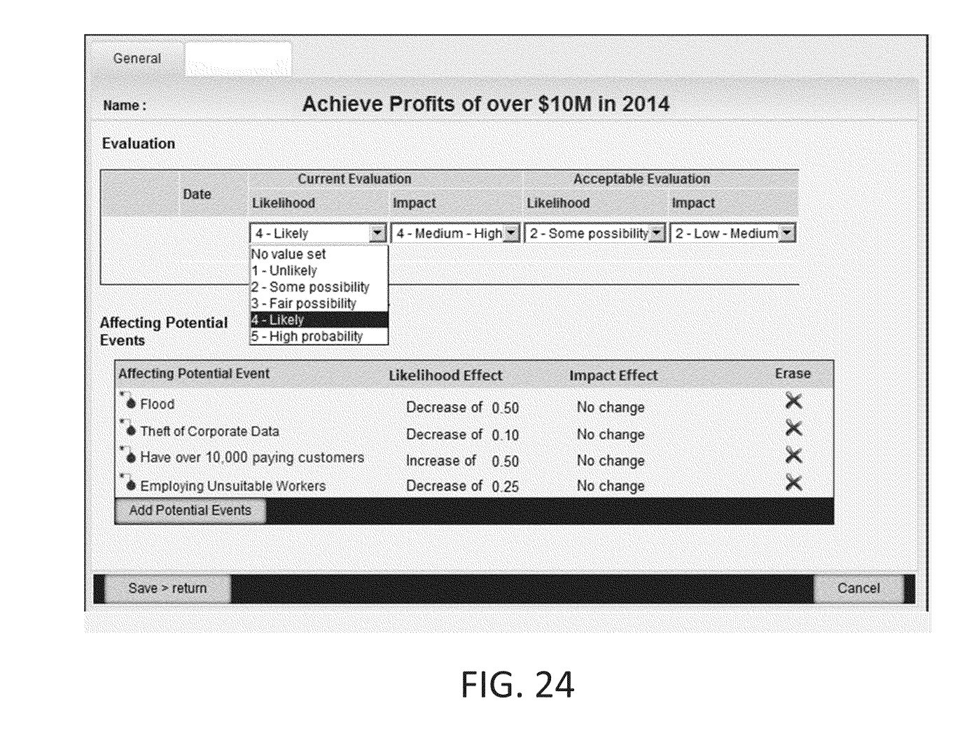

In step 203, the computerized apparatus outputs data on a computerized output device and receives input from a user, specifying potential events such as objectives, risks, opportunities and the like. Step 203 may employ data management functions such as adding, changing, deleting and printing data. In step 203, the computerized apparatus allows users to configure potential events such that changes in them will affect other potential events. One example of such configurations is a likelihood effect wherein a change in likelihood of one potential event has an effect on another. Another example of such configuration is an impact effect wherein a change in impact of one potential event has an effect on another. A mockup of output data configured for this step can be seen in FIG. 24. FIG. 24 depicts a GUI in which the potential event ‘Achieve Profits of over $10M in 2014’ is defined and may be modified. The potential event ‘Achieve Profits of over $10M in 2014’ has been evaluated by a user who has recorded the evaluation by specifying a value for 4 evaluation data items: Current evaluation likelihood, current evaluation impact, acceptable evaluation likelihood and acceptable evaluation impact. Current evaluation likelihood may express the current likelihood of the potential event occurring. Acceptable likelihood may express a likelihood (current or future) that the user deems acceptable to the body or organization for which the potential events are being managed. Evaluation impact may express the current impact to the organization if the potential event occurs. Acceptable impact may express an impact that the user deems acceptable if the potential event occurs. It is further noted that the said acceptable likelihood may be used at some future time to determine if a modified likelihood is acceptable to the organization and the said acceptable impact may be used at some future time to determine if a modified impact is acceptable to the organization. In other words, in an embodiment, the acceptable likelihood and acceptable impact could be used as a point of reference to assess the likelihood and impact following modification of the evaluated values. The user has assigned these values by selecting the appropriate value from a predefined list. Further relating to the screen of FIG. 24., the potential event is defined as being affected by four other potential events (‘Flood’, ‘Theft of corporate data’, ‘Have over 10,000 paying customers’. ‘Employing unsuitable workers’). With respect to each affecting potential event, a likelihood effect and impact effect are defined. The potential event ‘Flood’ is defined with a likelihood effect of ‘a decrease of 0.50’. This means that if the potential event ‘flood’ occurs, the evaluation likelihood of the effected event, ‘Achieve profits of over $10M in 2014’ will be effectively modified down by 0.50 on the scale of values for likelihood. Therefore in the example, if the potential event ‘flood’ occurs, and the evaluation likelihood of ‘Achieve profits of over $10M in 2014’ is ‘4—Likely’, the modified likelihood will be 4 less 0.50, that is 3.50. It will be noted that a modified value may not appear in the list of values associated with likelihood. For example, if likelihood is defined with 5 values: 1, 2, 3, 4, 5, the modified likelihood (3.50) can be expressed relative to the defined likelihood values, for example ‘between 4—likely and 3—fair possibility’. In a further example, if the likelihood effect had been ‘a decrease of 1.0’ and not ‘a decrease of 0.50’, the modified likelihood (if the potential event ‘flood’ occurred) would therefore be 3 and not 3.50, and so it would be modified down from 4 to 3, the modified value being 3-fair possibility. In a further example, if the likelihood effect had been ‘a decrease of 2.0’, the modified likelihood (if the potential event ‘flood’ occurred) would be modified down from 4 to 2, the modified value being 2—Some possibility. A similar logic may be applied to impact effect and evaluation impact, wherein if a potential event occurs, the evaluation impact of the effected event is modified based on the impact effect definitions.

In step 204, the computerized apparatus outputs data on a computerized output device and receives input from a user, specifying controls. A control is a process, procedure, practice, condition, stipulation or requirement whose purpose is to affect the likelihood of a potential event occurring. Examples of controls are: a requirement for 2 signatures on a document, an end-of-day procedure (e.g., procedure to be carried out at the end of the business day), a stock count and the wearing of protective clothing. A control may contain a specification of potential findings, which may specify effects on potential events. Potential findings may additionally be evaluated with a quality score, which may indicate an inherent assessment of the finding, such as for example, the performance of the control. Examples of potential events, controls, potential findings and some evaluated effects of findings on a potential event are given below:

### Example 1

Potential event: Injury to workers
Control: Workers must wear full protective clothing
Potential finding: That a worker was not wearing protective gloves
Evaluated effects of such a finding: A small increase in likelihood of the potential event, no change in the impact of the potential event and a quality score of not acceptable.

It is noted that the terms ‘small’, ‘large’, and ‘increase’ in the preceding and following examples are used to illustrate a broad relationship between a finding and a potential event; Specifying these properties is explained in detail in the explanation of step 203 above.

### Example 2

Potential event: Injury to workers
Control: Workers must wear full protective clothing
Potential finding: That a worker was not wearing protective helmet
Evaluated effects of such a finding: A large increase in likelihood of the potential event, a moderate increase in impact of the potential event and a quality score of highly unacceptable.

### Example 3

Potential event: Injury to workers
Control: Workers must wear full protective clothing
Potential finding: That a worker was wearing all protective clothing as required
Evaluated effects of such a finding: A moderate decrease in likelihood of the potential event, no change in impact of the potential event and a quality score of acceptable.

### Example 4

Potential event: Financial Catastrophe in the Organization
Control: Must be sufficient insurance cover
Potential finding: Cover of damage caused by earthquakes is not included in the insurance policy purchased
Evaluated effects of such a finding: An increase in the likelihood of the potential event, no change in the impact of the potential event and a quality score of highly unacceptable.

### Example 5

Potential event: Occurrence of an earthquake
Control: Must be sufficient insurance cover
Potential finding: Cover of damage caused by earthquakes is not included in the insurance policy purchased
Evaluated effects of the findings: An increase in the impact of the potential event, no change in the likelihood of the potential event occurring and a quality score of not acceptable.

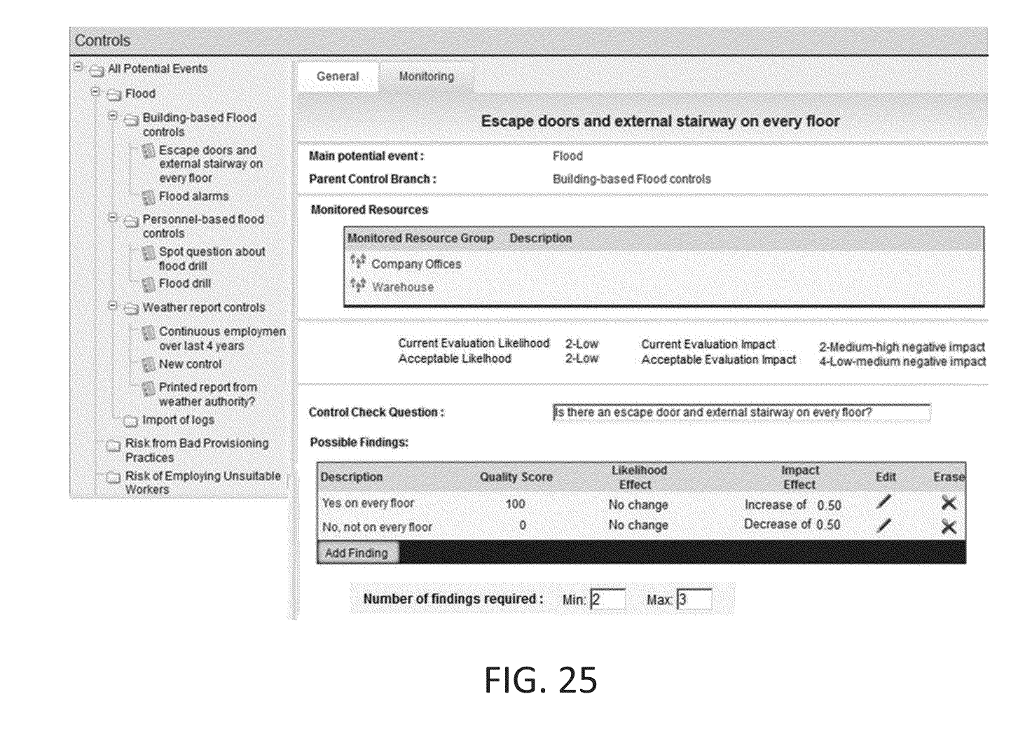

Step 204 may employ data management functions such as adding, changing, deleting and printing data. A mockup of output data configured for this step can be seen in FIG. 25. FIG. 25 depicts a GUI screen for configuring controls, according an embodiment of the disclosed subject matter showing, on the left side, a list of potential events (e.g., “flood”) and controls (e.g., “escape doors and external stairway on every floor”), logically grouped into control groups (e.g. “Building-based Flood controls”), that have been defined by a user and, on the right side, an input form for specifying the details of one control, defining a control monitoring task to be performed later by a user. It is noted that the control groups can be defined by users to assist them in arranging controls into a logical groups of controls. It is further noted that the controls groups can simplify the management of controls e.g. when assigning controls to a schedule, as described in more detail in FIG. 3 and the related description herein. The monitoring details include resource groups that specify the possible resources that will participate in the monitoring of the control, a control check question that will be presented to the user, and potential findings resulting from the observation. Each potential finding contains likelihood effect, impact effect and quality score. The quality score gives an indication of ‘how good’ the finding is. A score of 100 means such a finding would be satisfactory, whereas a quality score of 0 means such a finding would be unsatisfactory. In an embodiment, intermediate values may be possible too, such as 50 meaning partially satisfactory, for example. FIG. 25 depicts the definition of control ‘Escape doors and external stairway on every floor’, which belongs to the potential event, ‘Flood’.

Two monitored resource groups are specified for the control, both containing one or more monitored resources (the contained resources are not shown in FIG. 25). The resource group names ‘company offices’ and ‘warehouse’ may indicate that the resources observed in the control monitoring activity are buildings of some kind, either warehouses or offices. Below the resource groups, four evaluated values of the associated potential event are displayed: current evaluation likelihood (2—Low), current evaluation impact (2—Medium-high negative impact), acceptable evaluation likelihood (2—Low) and acceptable evaluation impact (4—Low-medium negative impact). These values are provided to assist the user in setting correct and reasonable values for the potential findings, explained in more detail below, and cannot be entered or changed on this screen. In another embodiment, these values may be inputted or modified in this screen. Similar values are further illustrated in an unrelated screen mockup depicting a different potential event in FIG. 24.

Referring again to FIG. 25, below the evaluation data is a control check question ‘Is there an escape door and external stairway on every floor?’, which will be presented to the user at the time of the control monitoring activity and below the control check question, potential findings are listed. 2 potential findings have been specified; the first ‘Yes on every floor’ has been assigned a quality score of 100 (indicating, in the current embodiment, a maximal score of 100/100), meaning such a finding is a satisfactory result; a likelihood effect of ‘no change’, meaning that such a finding will not have any effect on the likelihood of the potential event (Flood) occurring; and an impact effect of ‘increase of 0.50’, meaning that such a finding will have a modifying effect on the evaluation impact by increasing it from 2—Medium-high negative impact to 2.50, such that, with regard to an exemplary list of values for impact comprising 1—High negative impact, 2—Medium-high negative impact, 3—Medium negative impact, 4—Low-medium negative impact, 5—Low negative impact, 6, no impact, 7—Low positive impact, 8—Low-medium positive impact, 9—medium positive impact, 10—Medium-high positive impact, 11—High positive impact, the modified impact of the potential event, ‘Flood’ will be half-way between 2—Medium-high negative impact and 3—Medium negative impact. As a further illustration, had the impact effect been ‘increase of 1.00’ rather than ‘increase of 0.50’, the modified impact of the potential event, following such a finding, would be ‘3—Medium negative impact’. The second potential finding ‘No, not on every floor’ has been assigned a quality score of 0 (indicating, in the current embodiment, a score of 0/100), indicating such a finding is unsatisfactory; a likelihood effect of ‘no change’, meaning that such a finding will not have any effect on the likelihood of the potential event (Flood) occurring; and an impact effect of ‘decrease of 0.50’, meaning that such a finding will have a modifying effect on the evaluation impact by lowering it from 2—Medium-high negative impact to 1.50, such that, with regard to an exemplary list of values for impact comprising 1—High negative impact, 2—Medium-high negative impact, 3—Medium negative impact, 4—Low-medium negative impact, 5—Low negative impact, 6, no impact, 7—Low positive impact, 8—Low-medium positive impact, 9—medium positive impact, 10—Medium-high positive impact, 11—High positive impact, the modified impact of the potential event, ‘Flood’ will be half way between 2—Medium-high negative impact and 1—High negative impact. As a further illustration, had the impact effect been ‘decrease of 1.00’ rather than ‘decrease of 0.50’, the modified impact of the potential event, following such a finding, would be ‘1—High negative impact.

At the bottom of the screen, 2 fields marked Min and Max are provided for the user to specify a number of findings to be recorded for a scheduled occurrence of the current control, and these may specify a minimum and maximum number of findings required. Following a later scheduling of the control and following the specified scheduled date (described in FIG. 3), a number of recorded findings falling below the specified minimum may cause the control monitoring to be considered incomplete. A number of recorded findings greater than the specified maximum may cause some findings to be ignored in computations.

FIG. 3 is a flowchart illustrating steps of scheduling control activity, according to an embodiment of the disclosed subject matter. In some exemplary embodiments, the steps of FIG. 3 may be performed as part of step 102 of FIG. 1.

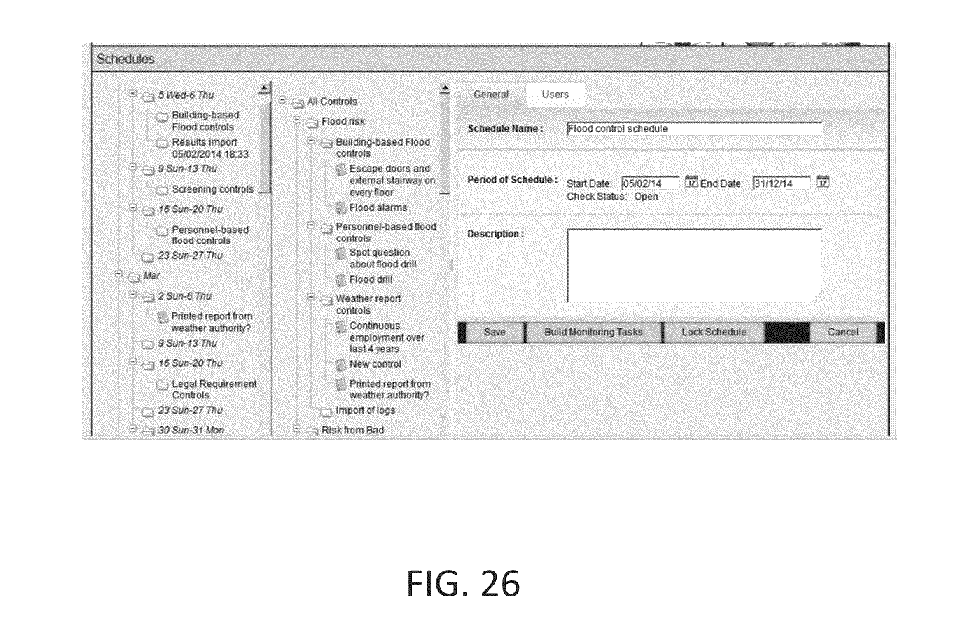

In step 301, the computerized apparatus outputs data on a computerized output device and receives input from a user, specifying data comprising of controls to be monitored and a scheduled time for the monitoring activity to take place. In some embodiments, the data described in the current paragraph constitutes a ‘schedule’. In some embodiments, the data described in the current paragraph constitutes a ‘plan’. In some embodiments, controls are scheduled to be monitored at a scheduled time and the associating of the controls with the scheduled time can be done by associating a group containing more than one control in a single action. It should be noted that this association of a group of controls in a single action may have significance in its ability to schedule many controls in a single user action. In some embodiments, the group of controls may take a hierarchical structure such as the form of a tree structure, or part thereof. Step 301 may employ data management functions such as adding, changing, deleting and printing data. The scheduling data may or may not include reference to the resources to be observed in the control monitoring activity. In some embodiments, one or more schedules may be managed. In some embodiments, a scheduled time may be a date, a time of day, a time frame, or the like. In some embodiments, every schedule may have a status for the purpose of manageability and the values of the schedule status may be: ‘Not ready’, meaning the schedule is still in the planning or building stage and the building of monitoring tasks has not yet been done and findings cannot be recorded for the controls contained in the schedule; ‘Open’, meaning the schedule is operational and the building of monitoring tasks has been done and findings can be recorded for the controls contained in it; and ‘Locked’, meaning no further changes can be made to the schedule such as recording findings or changing the scheduled controls. A possible example of ‘locked status’ is when a user decides to build a new schedule every year and to ‘lock’ the previous year's schedule to prevent further work on it. A mockup of output data configured for this step can be seen in FIG. 26. In FIG. 26 a button ‘Lock Schedule’ can be seen which, when clicked with a pointing device (e.g., a mouse, a touch screen, or the like), puts the schedule into ‘Locked’ status.

In step 302, the computerized apparatus receives a request from a user to create monitoring tasks for a selected schedule. As an example, the user may, using a pointing device, click the ‘Build monitoring tasks’ button seen in FIG. 26 to provide the build request. The purpose of the build is to transform a schedule from the planning stage to the operational stage. This transformation includes identifying the controls contained in control groups that have been scheduled, and additionally identifying the controls that have been scheduled directly (i.e. individually and not as a control group), and building from them individual monitoring tasks—one task for each scheduled control. The individual monitoring tasks are the part of the schedule that informs users which controls need to be monitored and for which they are expected to input findings, as described in more detail in FIG. 4 and the related description herein.

In step 303, the computerized apparatus identifies any existing control monitoring tasks without findings, such as may occur if a previous build request has been received and handled. Such tasks may no longer be required and may be deleted by the computerized apparatus. The purpose of step 303 is to ‘clean up’ before ‘rebuilding’ the monitoring tasks. After the completion of a first iteration of the steps of scheduling control activity as depicted in FIG. 3, monitoring tasks will have been created but no findings will yet have been recorded. Thereafter, the recording of findings commences as described in FIG. 4. It is possible, even expected, that after findings have been recorded for a schedule, a change will be made to the schedule. Such a change might involve the addition, changing or removal of controls from the schedule. In the event of such a change, the control monitoring tasks will need to be updated to reflect the changes in the schedule. If a control is removed from the schedule and no findings have been recorded for it, it can and should be removed as a monitoring task as well. If however, findings have been recorded, they may not be removed, nor may the control be removed from the associated monitoring tasks.

In step 304, the computerized apparatus retrieves the schedule and identifies all the controls specified therein, including controls that have been assigned directly and controls that have been assigned to the schedule indirectly, by assigning a group of controls (as illustrated in step 301 and its explanation herein).

In step 305, the computerized apparatus creates monitoring tasks, based on the controls that were identified in step 304. In an embodiment, the computerized apparatus creates one monitoring task for each control identified in step 304. In an embodiment, a list of the said monitoring tasks can later be outputted to a user to inform the user of the control activity required.

In some cases, a user may perform the monitoring tasks and provide findings. Additionally or alternatively, some monitoring tasks may be automatically performed, such as by a computerized device, based on the monitoring tasks. After performing the monitoring tasks, findings may be automatically determined. The determining or otherwise providing of the findings is illustrated in FIG. 4 and explained in the description contained herein.

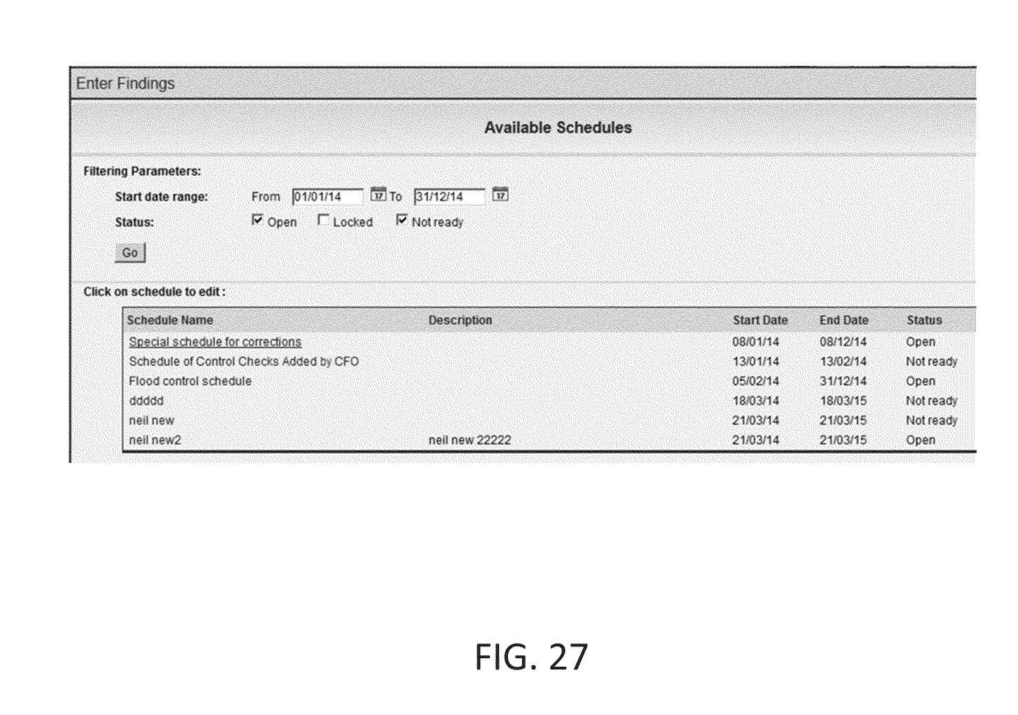

In step 306, the computerized apparatus changes the schedule status from ‘not ready’, which is its default status, to ‘open’, to indicate to a user that findings may be input for the schedule. A list of schedules having different statuses is illustrated in FIG. 27, which shows some schedules with a status of ‘open’ and others with a status of ‘not ready’.

FIG. 4 is a flowchart illustrating steps of managing findings from control monitoring activity, according to an embodiment of the disclosed subject matter. In some exemplary embodiments, the steps of FIG. 4 may be performed as part of step 104 of FIG. 1.

It is noted that the steps described herein enable users to know what controls have been scheduled and further enables them to input findings as required.

In step 401, the computerized apparatus outputs data on a computerized output device displaying schedules for which findings may be input. A mockup of such a screen appears in FIG. 27. The available schedules may be displayed in accordance with filtering criteria such as schedules that are scheduled for the present day, the present week, the present month, or any other time point or time range. Examples of other filtering criteria are status and type.

In step 402, the computerized apparatus receives input from a user, through a computerized input device, specifying a chosen schedule for which findings will be input.

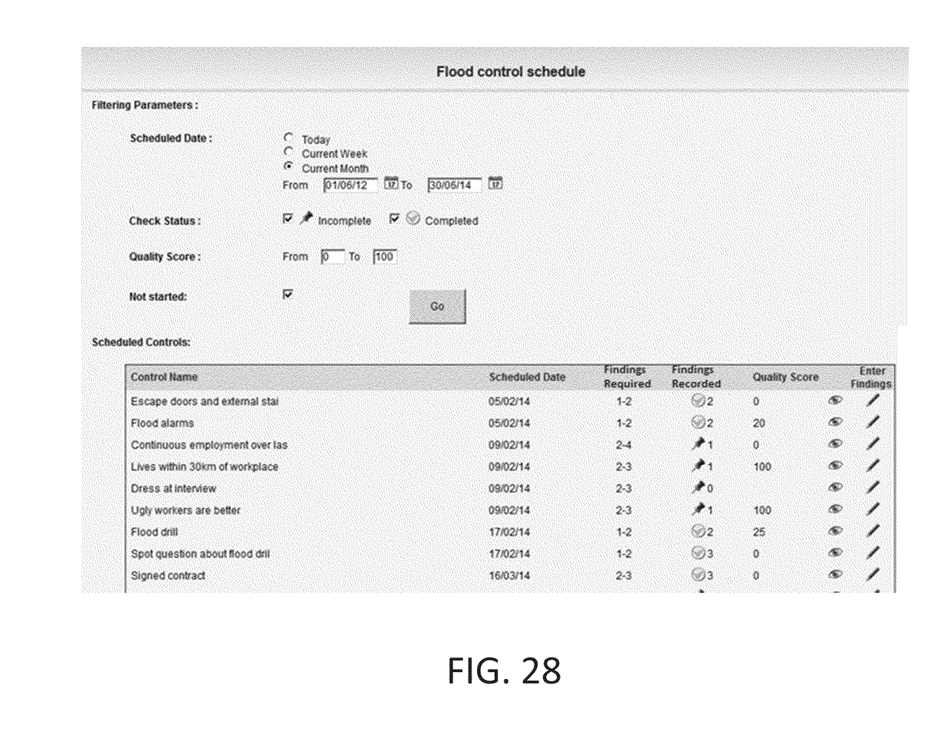

In step 403, the computerized apparatus outputs data on a computerized output device, displaying controls related to the chosen schedule, for which findings may be input. A mockup of such a screen appears in FIG. 28, in which controls of the schedule “Flood control schedule” are depicted. In FIG. 28, filtering criteria appear in the upper part of the screen, the selection of which may assist the user in identifying a desired control. In the lower part of the screen, a list of controls is displayed comprising data specified for each control including control name and findings required, the findings required consisting of a range representing a minimum and maximum number of findings required (for example 1-2 for the first listed control ‘escape doors and external stairways’, 1 being the minimum and 2 being the maximum number) and these numbers may serve to inform or guide a user to obtain and record the required minimum and maximum number of findings. The maximum number of required findings may further serve to inform or guide a user that in the event of a larger number of findings being recorded than the maximum number of required findings, findings beyond the maximum number required may be excluded from computations. In an embodiment, the excluded findings may be the least recent findings. A specification of Maximum and minimum numbers of findings may be seen in the exemplary embodiment of a control specification of FIG. 25.

The list of controls of FIG. 28 additionally comprises statistical data, such as the number of findings recorded and quality score, which refers to the aggregated quality score of the findings recorded for the control, for which an exemplary method of calculation is illustrated in FIG. 6 and the description herein. The list of controls further comprises the date for which the monitoring of the control has been scheduled.

In step 404, the computerized apparatus receives input from a user, through a computerized input device, specifying a chosen control for which findings will be input.

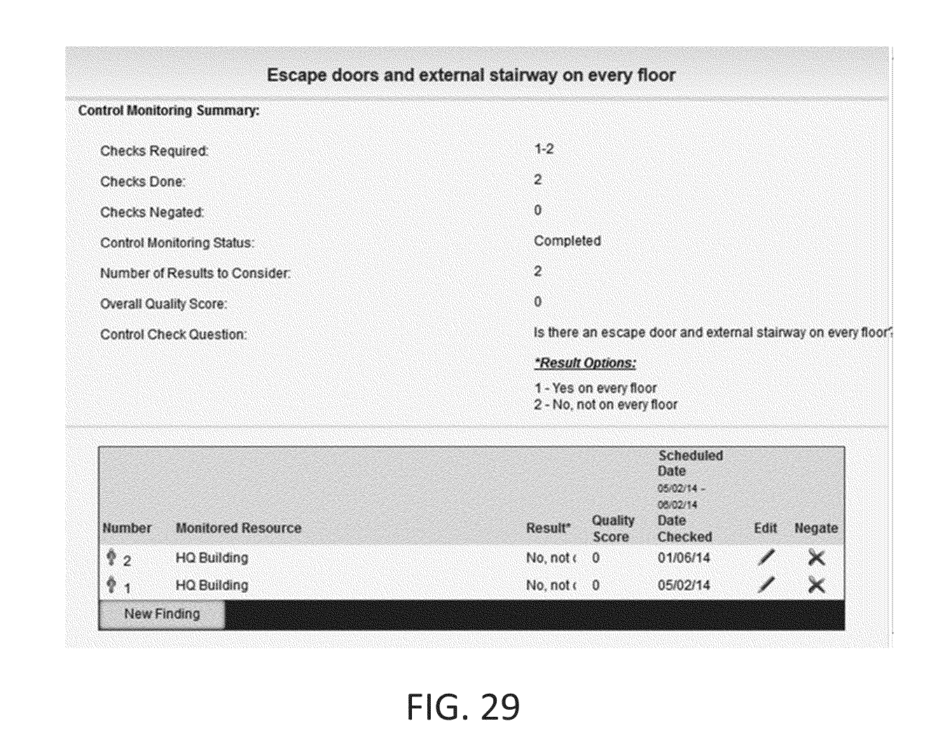

In step 405, the computerized apparatus outputs data on a computerized output device displaying previously received findings, if any, for the chosen control. In some cases, the user may input a result of the monitoring of the control and a date thereof. In some cases, the date may be the current date in which the finding is inputted to the system. A mockup of such a screen appears in FIG. 29. Step 405 may employ data management functions such as adding, changing, deleting and printing data.

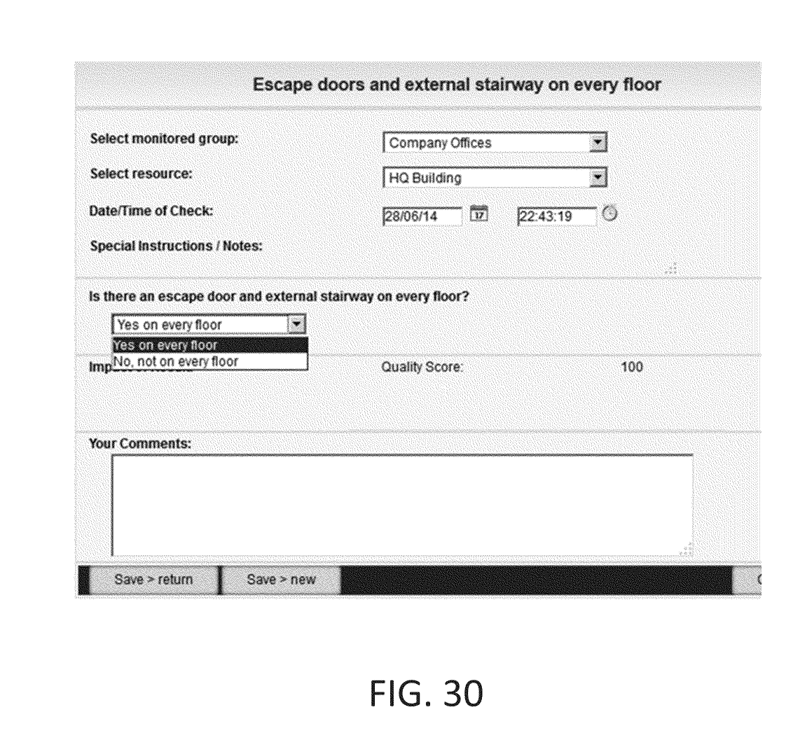

In step 406, the computerized apparatus receives input from a user, through a computerized input device, requesting to input new findings data. This is illustrated in FIG. 29 by the ‘New Finding’ button which when pressed causes the computerized apparatus to display a form that can be used to provide the content of the new finding. FIG. 30 exemplifies a mockup of such a form.

In step 407, the computerized apparatus receives input from a user, through a computerized input device, specifying a resource group associated with the finding. This may or may not include a preliminary displaying of a list of resource groups for selection. Referring again to FIG. 30, the “monitored group” field may be used to select a resource group from a pre-defined list of resource groups, which may have been defined in step 202 of FIG. 2. In some embodiments, the number of resource groups that may be specified is not limited.

In step 408, the computerized apparatus receives input from a user, through a computerized input device, specifying the resource associated with the finding. This may or may not include a preliminary displaying of a list of resources for selection. In some exemplary embodiments the list may include all resources in the resource group selected in the previous step. The list may include all defined resources in the system. In some exemplary embodiments, a subset of the resources may be displayed based on pre-defined configurations associating resources with potential events, schedules, controls, or the like. Referring again to FIG. 30, the “select resource” may be used to select a resource from a pre-generated list of resources that are comprised by the selected resource group. In some embodiments, the number of resources that may be specified is not limited.

In step 409, the computerized apparatus outputs data on a computerized output device displaying a check question (e.g., ‘Is there an escape door and external stairway on every floor?’ from FIG. 25), and a list of potential findings. These may be the same data items —check question and potential findings—defined by a user as described in step 204 and illustrated in FIG. 25. Referring again to FIG. 30, the potential findings can be seen in the combo box containing ‘Yes, on every floor’ and ‘No, not on every floor’.

In step 410, the computerized apparatus receives input from a user, through a computerized input device, specifying the selection of a finding from the list of potential findings in step 409. Referring again to FIG. 30, the selection in the illustration that has been made by a user is ‘Yes, on every floor’. In an embodiment, settings associated with the selected finding can be displayed to the user, for example, the quality score, which can be seen with a value of 100.

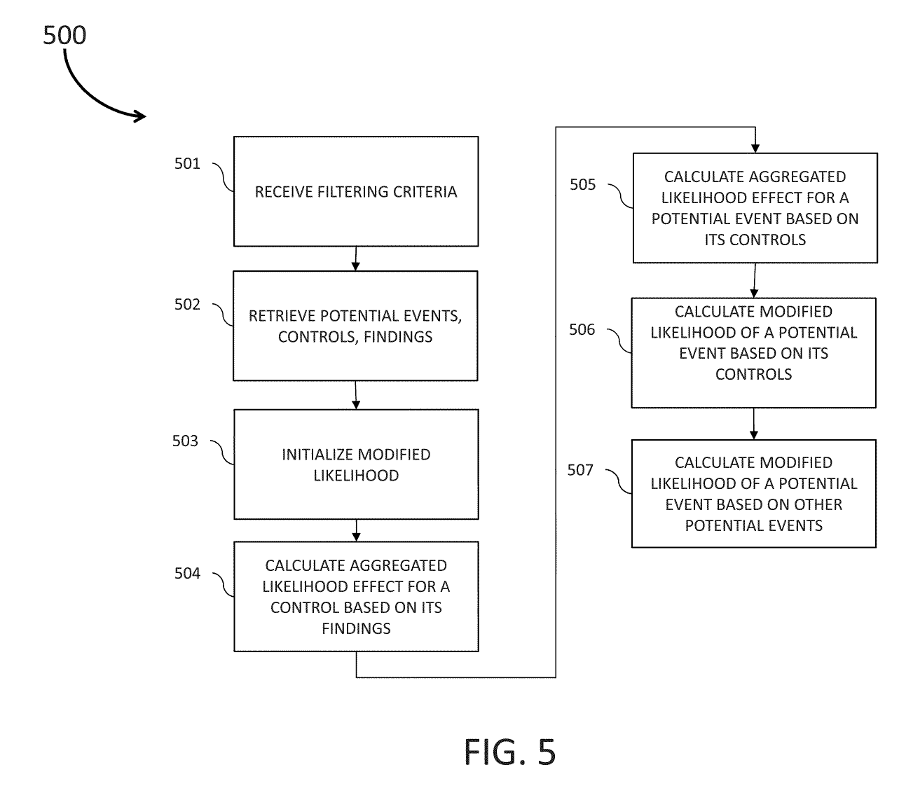

FIG. 5 is a flowchart illustrating a method of modifying likelihood of potential events, using aggregation, in accordance with some embodiments of the disclosed subject matter.

It is noted that a similar set of drawings to FIG. 5 and its elaborations in FIGS. 6-9 could be produced to illustrate a similar calculation for a different evaluation characteristic of a potential event, for example, calculation of modified impact, with the term ‘likelihood’ replaced by ‘impact’ in the said drawings and associated descriptions herein.

In step 501, filtering criteria are received in order to achieve a result that reflects a certain subset of the organization, such as findings within specified dates, selected organizational units and the like.

In step 502, the computerized apparatus retrieves the appropriate data (e.g., potential events, controls, findings, or the like) in accordance with the filtering criteria received in step 501.

In step 503, the computerized apparatus initializes the modified likelihood for all selected potential events such that modified likelihood=evaluation likelihood. The modified likelihood may or may not be further updated in subsequent steps of FIG. 5. For example, step 506 may or may not further update the modified likelihood and step 507 may or may not further update the modified likelihood.

In step 504, the computerized apparatus calculates an aggregated likelihood effect for a control, by aggregating the likelihood effect for each of the relevant findings of the control. Step 504 is repeated for all controls in the selection. Step 504 is described in more detail in FIG. 6 and the description herein.

In step 505 the computerized apparatus aggregates the aggregated likelihood effect of all relevant controls calculated in step 504 into an aggregated likelihood effect for the potential event for which the controls are defined. Step 505 is further elaborated in FIG. 7 and the description herein.

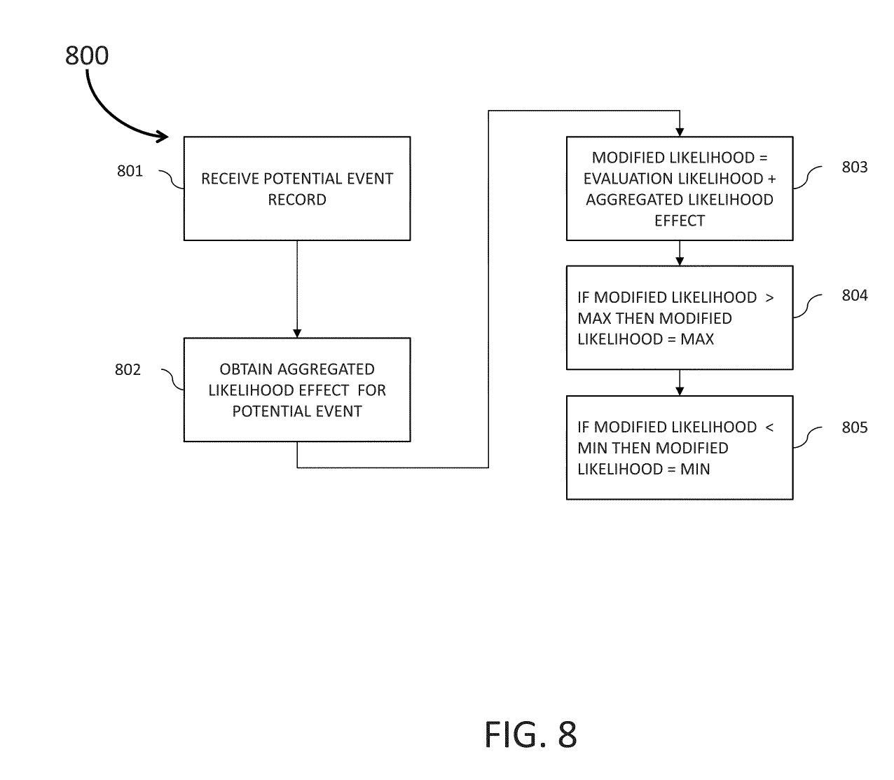

In step 506, the computerized apparatus calculates a modified likelihood for the potential event, based on its evaluation likelihood and the aggregated likelihood effect calculated in step 505. Step 506 is further elaborated in FIG. 8 and the description herein. Steps 505 and 506 are repeated for all other potential events for which controls are defined.

All relevant potential events, for which controls are defined, now have a modified likelihood. The modified likelihood may or may not be different from the evaluated current likelihood.

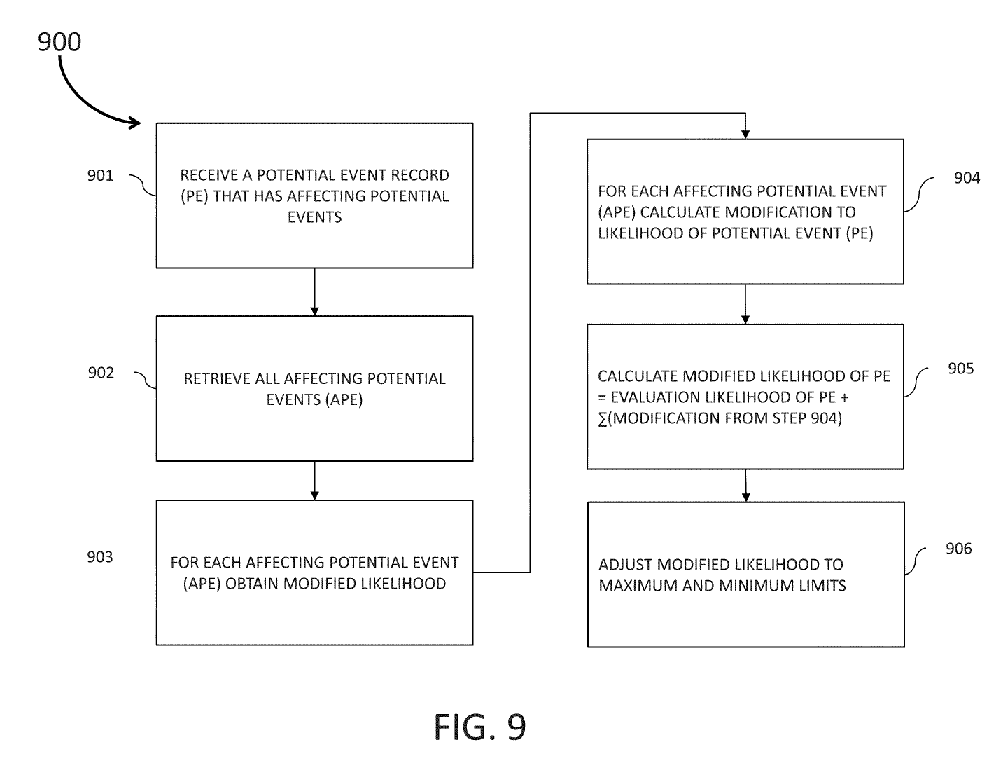

In step 507 the computerized apparatus modifies the likelihood of a potential event which is dependent on one or more other potential events following the calculation of the other potential events' modified likelihood. Step 507 is repeated for all potential events that are dependent on other potential events. Step 507 is further elaborated in FIG. 9 and the description herein. In some cases, the computation of step 507 may be performed together with that of step 506 in order to produce a modified likelihood. A single function may be used to take into account both the effects of the aggregated likelihood effect of the relevant controls and of the other potential events that may affect the likelihood of the potential event.

In some exemplary embodiments, a graph of effects between controls and potential events may be constructed. The graph may be an acyclic graph. A node in the graph may represent either a control or a potential event. An edge between node A to node B may represent an effect of the likelihood effect of the item represented by node A on the likelihood effect of the item represented by node B. The graph may be used to define an order of computation, such as a topological sort of the graph.

The steps of FIG. 5 described above are further elaborated in subsequent drawings FIG. 6-FIG. 9.

FIG. 6 is a flowchart illustrating a method for computing aggregated findings data for a control, in accordance with some embodiments of the disclosed subject matter. In some exemplary embodiments, the steps of FIG. 6 may be performed as part of step 504 of FIG. 5.

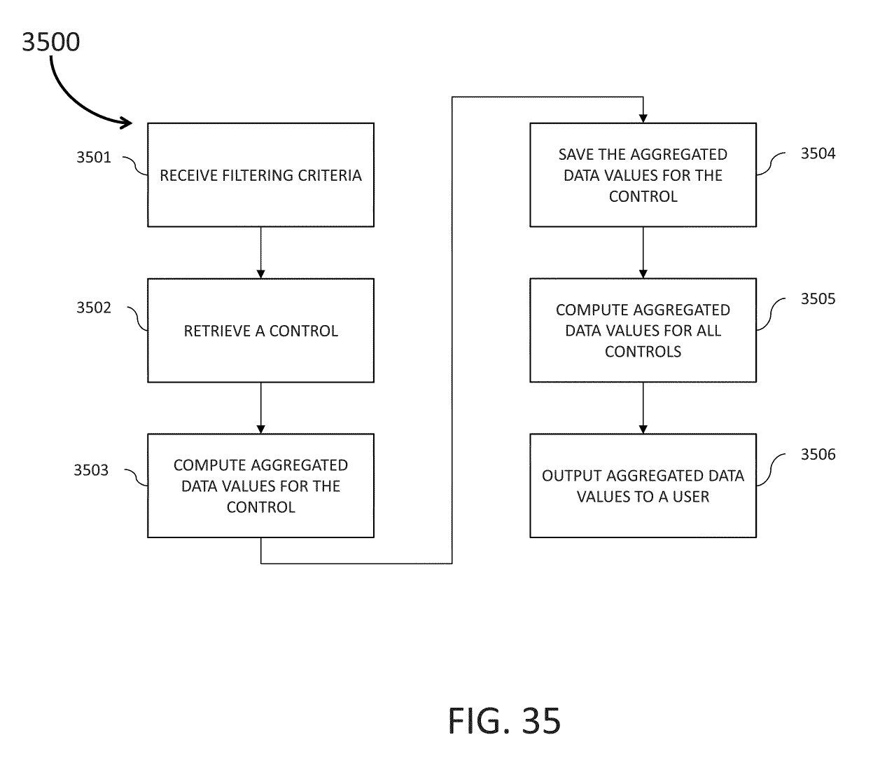

In some exemplary embodiments, the steps of FIG. 6 may be performed as part of step 3503 of FIG. 35.

In step 601, the computerized apparatus receives a control record which it uses in step 602 to identify the appropriate findings associated with the control.

It is noted that in some embodiments, minimum and maximum numbers of required findings may be specified for a control, as discussed in the description of step 204 of FIG. 2 and step 403 of FIG. 4.

In step 602, the computerized apparatus retrieves findings for the control. In some embodiments, a number of most recent findings will be retrieved, the number being determined by a previously defined maximum required number of findings, which may be specified in the control configuration. ‘Most recent’ may refer to retrieving the findings in a reverse chronological sequence such that in the event of the existence of a greater number of findings than the maximum number of findings, the most recent findings will be retrieved and the less recent findings, beyond the maximum required number of findings, will not be retrieved. In an embodiment, the excluded findings may be the least recent findings.

In an embodiment, the total number of findings retrieved for a control may fall below a required minimum number of findings. In one embodiment, the occurrence of the total number of findings retrieved falling below a required minimum number of findings may not affect the computation of an aggregated value. In another embodiment, the occurrence of the total number of findings retrieved falling below a required minimum number of findings may render any computation of an aggregated value inherently invalid. In yet another embodiment, the occurrence of the total number of findings retrieved falling below a required minimum number of findings may affect the computation of an aggregated value such that a number of findings below the required minimum number of findings may be considered as having been recorded, even though they were not in fact recorded, wherein findings ‘considered as having been recorded’ may be further considered as having a predefined value.

In an exemplary occurrence, the said predefined value may represent an undesirable value such that the lack of a required finding is tantamount to the existence of an undesirable finding. One such exemplary occurrence is a minimum number of findings of 2 and an actual number of recorded findings of 1 wherein a computation of aggregated quality score would consider 2 findings—one being the actual recorded finding and the other being considered as if recorded, with a quality score of 0, meaning ‘not acceptable’.

In step 603 the computerized apparatus computes aggregates findings data from findings selected in step 602, including for example, likelihood effect, impact effect and quality score. One embodiment of the aggregation algorithm is a mean average of each of the said data values. Other embodiments may use alternative aggregation algorithms, such as but not limited to summation, weighted average, or the like.

In step 604, the aggregated findings data, from 603, such as aggregated likelihood effect, aggregated impact effect and aggregated quality score, is saved for the control of step 601.

FIG. 7 is a flowchart illustrating a method for calculating an aggregated likelihood effect for a potential event, in accordance with some embodiments of the disclosed subject matter. In some exemplary embodiments, the steps of FIG. 7 may be performed as part of step 505 of FIG. 5.

In step 701, the computerized apparatus receives a potential event record which it uses in step 702 to retrieve the appropriate controls associated with the potential event.

In step 703 the computerized apparatus obtains the aggregated likelihood effect from all controls retrieved in step 702. The aggregated likelihood effects may be obtained by using the method of FIG. 6. The computerized apparatus computes an aggregated likelihood effect for the potential event by summing the said likelihood effect values obtained from the controls. Other embodiments may use alternative aggregation algorithms.

In step 704, the aggregated likelihood effect computed in 703 is saved for the potential event of step 701.

It is noted that a similar set of steps to those of FIG. 7 could be produced for aggregation of impact effect, or other values.

FIG. 8 is a flowchart illustrating an exemplary embodiment of a method for calculating a modified likelihood for a potential event, based on its controls, in accordance with some embodiments of the disclosed subject matter. In some exemplary embodiments, the steps of FIG. 8 may be performed as part of step 506 of FIG. 5.

In step 801, one potential event record is received by the computerized apparatus, the potential event record containing an evaluation likelihood, previously assigned by a user.

In step 802, the computerized apparatus obtains the aggregated likelihood effect on the potential event, which may have been calculated previously in the series of steps in FIG. 7. In some embodiments, the steps of FIG. 7 may be performed as part of step 802.

In step 803, the computerized apparatus calculates a modified likelihood for the potential event by adding the aggregated likelihood effect obtained in step 802 to the current evaluation likelihood. In some exemplary embodiments, the aggregated likelihood effect may be added to an already modified likelihood. In some embodiments, the computed modified likelihood may be computed based on a function which takes into account the current evaluation likelihood as well as an aggregated likelihood effect. The function may be configured to apply the aggregated likelihood effect on the evaluation likelihood to compute the modified likelihood. In some embodiments, the function may be addition or subtraction of an absolute value, addition or subtraction of a percentage value, multiplication, or the like.

In step 804, if the modified likelihood as computed in Step 803 exceeds a maximal threshold, such as a maximal likelihood value, the modified likelihood may be set to the maximal likelihood value. As an example, if the modified likelihood has been computed as 6 and maximal likelihood has been defined as 5, the computerized apparatus further modifies the modified likelihood by assigning to it a value of 5. In some embodiments, a maximal value may be explicitly specified. In some embodiments a maximal value may be implicitly derived from the highest sequence of predetermined likelihood values, for example in a range of likelihood values of 1-5, the maximal value may implicitly be considered as 5.

In step 805, if the modified likelihood as computed in step 803 is below a minimal threshold, such as a minimal likelihood value, the modified likelihood may be set to the minimal likelihood value. As an example, if the modified likelihood has been computed as −2 and the minimal likelihood value has been defined as 0, the computerized apparatus further modifies the modified likelihood by assigning to it a value of 0. In some embodiments, a minimal value may be explicitly specified. In some embodiments a minimal value may be implicitly derived from the lowest sequence of predetermined likelihood values, for example in a range of likelihood values of 1-5, the minimal value may implicitly be considered as 1.

It should be noted that in some embodiments, steps of FIG. 8 may precede steps of FIG. 9, where the potential events received in step 801 are configured to affect one or more potential events received in step 901. This may ensure all modified likelihoods and likelihood effects pertaining to the affecting potential events retrieved in the method of FIG. 9 are properly and fully computed.

FIG. 9 is a flowchart illustrating an exemplary embodiment of a method for calculating a modified likelihood for a potential event, based on other potential events, in accordance with some embodiments of the disclosed subject matter. In some exemplary embodiments, the steps of FIG. 9 may be performed as part of step 507 of FIG. 5.

In step 901, one potential event record, which has been configured to be affected by other potential events, is received by the computerized apparatus. In some embodiments, the computerized apparatus may retrieve the potential event record from a database, such as based on a database query.

In step 902, the computerized apparatus retrieves all potential events which have been configured to affect the potential event of step 901.

In step 903, the computerized apparatus obtains the modified likelihood values for the potential events retrieved in step 902. In some embodiments, the modified likelihood may be obtained using the method of FIG. 8, for calculating a modified likelihood, as part of step 903. In some embodiments, the method of FIG. 8 may have been already applied to each of the retrieved, affecting potential events as depicted in step 506 of FIG. 5. Each of the retrieved potential events has a modified likelihood, which may have the same value as the evaluation likelihood or a different value.

In step 904, for each of the affecting potential events retrieved in 902, the computerized apparatus computes a modification to be made to the likelihood of the affected potential event of step 901, producing a modified likelihood, which may reflect modifications to the likelihood of the affecting events of 902. This modification may be calculated as follows:

Modification to likelihood=
(Modified likelihood of affecting potential event−evaluation likelihood of affecting potential event)/number of values in likelihood sequence*likelihood effect of affecting potential event on affected potential event.

An example of a modification follows:

The data:
Likelihood scale contains 5 values: 1—Very low, 2—Low, 3—Average, 4—High, 5—V-High
Evaluation likelihood of affecting potential event=2
Modified likelihood of affecting potential event=3.5
Likelihood effect of affecting potential event on affected potential event=0.5
   The calculation:

### Modification=

(Modified likelihood of affecting potential event (3.5)−evaluation likelihood of affecting potential event (2))/number of values in likelihood sequence (5)*likelihood effect of affecting potential event on affected potential event (0.5)
=(3.5−2)/5*0.5=0.15

In step 905, the modified likelihood of the potential event in 901 is calculated by adding all modifications computed in step 904 to the current value of the evaluation likelihood as follows:
Modified likelihood of potential event=(evaluation likelihood of potential event)+Σ(modifications to likelihood from step 904)

In some exemplary embodiments, the modification may be added to an already modified likelihood. One example of this is when a prior computation has been made of modified likelihood, based on the controls of the potential event.

In step 906, if the modified likelihood computed in step 905 exceeds a maximal threshold, such as a maximal likelihood value, the modified likelihood may be set to the maximal likelihood value. As an example, if the modified likelihood has been computed as 6 and maximal likelihood has been defined as 5, the computerized apparatus further modifies the modified likelihood by assigning to it a value of 5. If the modified likelihood computed in step 905 is below a minimal threshold, such as a minimal likelihood value, the modified likelihood may be set to the minimal likelihood value. As an example, if the modified likelihood has been computed as −2 and the minimal likelihood value has been defined as 0, the computerized apparatus further modifies the modified likelihood by assigning to it a value of 0.

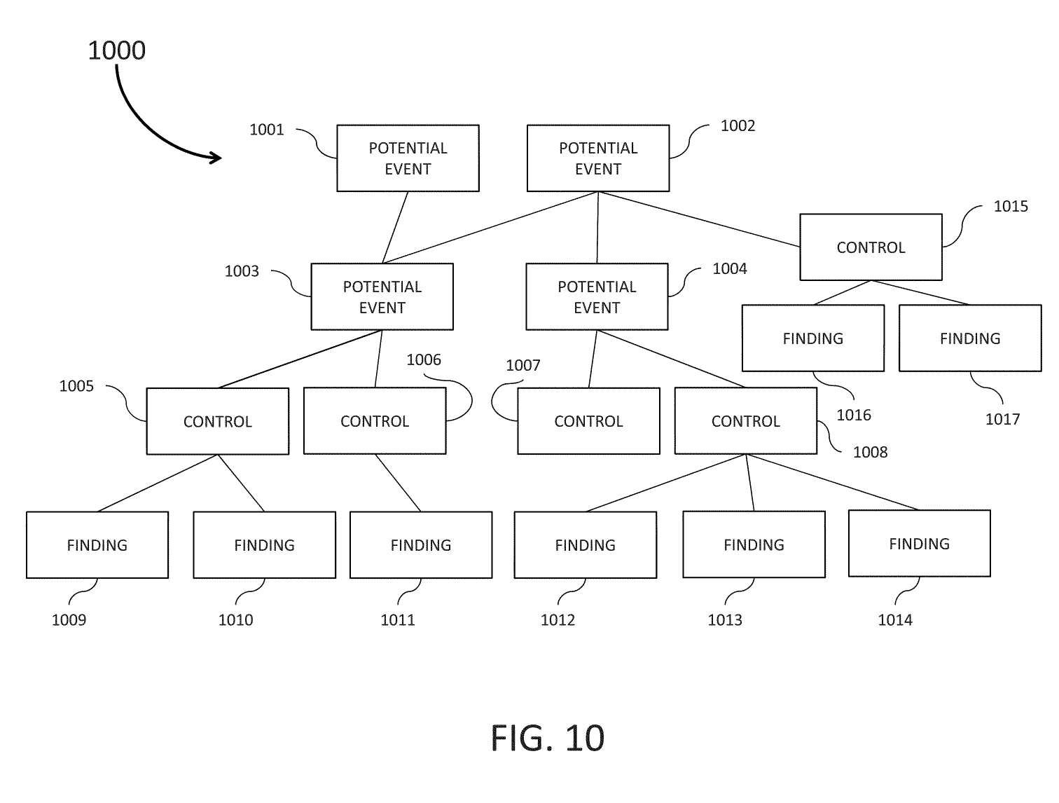

It should further be noted that potential events for which a modified likelihood is calculated in the steps of FIG. 9 may affect other potential events, therefore the steps of FIG. 9 should first be executed on potential events ‘lower down’ in the potential event hierarchy and then on those ‘higher up’ in the hierarchy. This is illustrated in FIG. 10, wherein potential events 1001 and 1002 are higher in the hierarchy and 1003 and 1004 are lower in the hierarchy. This can be explained also in terms of affecting potential events (i.e. 1003 and 1004) and affected potential events (i.e. 1001 and 1002).

FIG. 10 is an illustration of a configuration of data elements, in accordance with some embodiments of the disclosed subject matter.

1001 and 1002 are potential events that do not affect other potential events. 1001 and 1002 are affected by other potential events. 1001 is affected by 1003. 1002 is affected by 1003 and 1004. Potential event 1002 additionally has 1 control 1015 defined for it, the control having 2 findings, 1016 and 1017. Potential event 1003 has 2 controls defined for it: control 1005 having 2 findings 1009 and 1010, and control 1006 having one finding 1011. Potential event 1004 has 2 controls defined for it: control 1007 having no findings and control 1008 having 3 findings 1012, 1013 and 1014.

In some embodiments, a graph similar to the configuration depicted in FIG. 10 may be generated and a topological sort may be employed in order to define an order of computation of modified likelihoods and/or modified impacts of potential events.

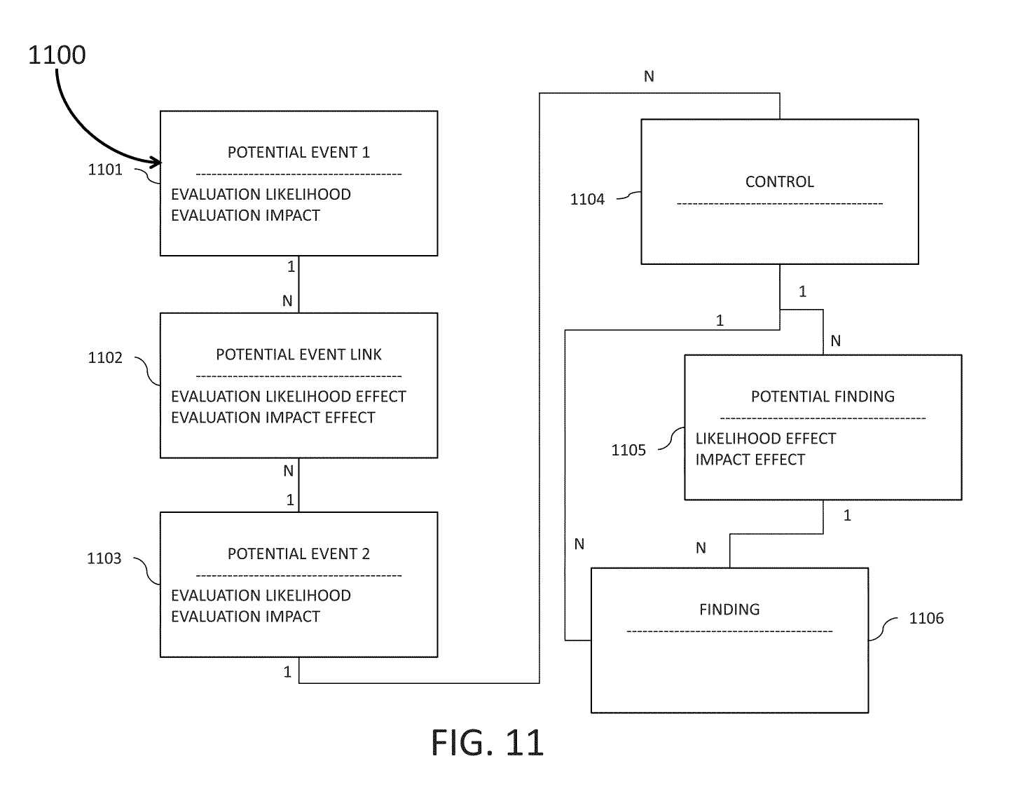

FIG. 11 is an entity relation diagram illustrating data elements involved in calculating a modified likelihood for a potential event, and/or involved in calculating a modified impact for a potential event, in accordance with some embodiments of the disclosed subject matter.

In some exemplary embodiments, FIG. 11 may illustrate entities in a relational database used by a computerized apparatus in accordance with the disclosed subject matter.

1101 and 1103 are potential events. They contain data: evaluation likelihood and evaluation impact, which are assigned a value by a user, in accordance with the user's evaluation.

1102 is a potential event link that logically connects two potential events when one potential event may be affected by the other. It contains data: evaluation likelihood effect and evaluation impact effect of one potential event on another.

1104 is a control. In the exemplary embodiment of FIG. 11, each control is linked to one potential event. In other embodiments a control can be linked to more than one potential event. A potential event can be linked to any number of controls, including none.

1105 is a potential finding. It contains data: likelihood effect and impact effect of a finding on a potential event, which is data that can be aggregated to create modified values for likelihood and impact. Each potential finding can be linked to one control. A control can be linked to any number of potential findings, including none.

1106 is a finding, each finding being linked to one control. A control can be linked to any number of findings, including none. Each finding refers to one potential finding. A potential finding can be linked to any number of findings, including none.

The evaluation likelihood and evaluation impact of potential events and the evaluation likelihood effect and evaluation impact effect of potential events on other potential events are values assigned by a user, in accordance with the user's evaluation. The evaluation data may be updated at any time by a user. Updating evaluation data does not transform it into ‘modified’ data. Calculations of ‘modified’ data make use of evaluation data.

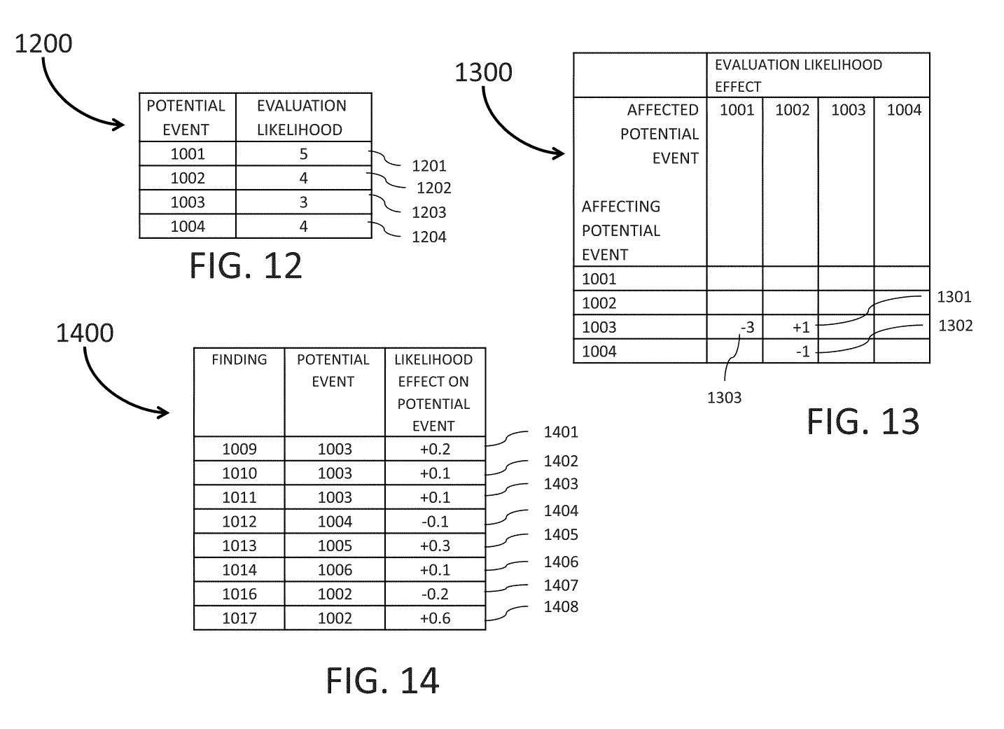

FIGS. 12, 13 and 14 illustrate some data in the data elements involved in calculating a modified likelihood for a potential event, in accordance with the disclosed subject matter and example configuration of FIG. 10.

FIG. 12 is a table illustrating potential events and their evaluation likelihood, in accordance with some embodiments of the disclosed subject matter. FIG. 12 illustrates 4 potential events from FIG. 10 and their evaluation likelihood. Potential event 1001 from FIG. 10 has been assigned an evaluation likelihood 1201 of 5. Potential event 1002 from FIG. 10 has been assigned an evaluation likelihood 1202 of 4. Potential event 1003 is from FIG. 10 has been assigned an evaluation likelihood 1203 of 3. Potential event 1004 from FIG. 10 has been assigned an evaluation likelihood 1204 of 4.

FIG. 13 is a table illustrating evaluation likelihood effects of potential events on other potential events, in accordance with some embodiments of the disclosed subject matter. FIG. 13 illustrates 3 evaluation likelihood effects of potential events on other potential events, from FIG. 10 thereby creating a dependency relationship between 2 potential events, the one being the affecting potential event and the other being the affected (or dependent) potential event. 1301 is the evaluation likelihood effect of 1003 on 1001, which is −3. 1302 is the evaluation likelihood effect of 1003 on 1002, which is +1 and 1303 is the evaluation likelihood effect of 1004 on 1002, which is −1.

FIG. 14 is a table illustrating findings and the likelihood effect of each finding on the potential event, in accordance with some embodiments of the disclosed subject matter. FIG. 14 illustrates 8 findings from FIG. 10 and the likelihood effect of each finding on its associated potential event. The likelihood effect 1401 (from finding 1009) is +0.2; the likelihood effect 1402 (from finding 1010) is +0.1; the likelihood effect 1403 (from finding 1011) is +0.1; the likelihood effect 1404 (from finding 1012) is −0.1; the likelihood effect 1405 (from finding 1013) is +0.3; the likelihood effect 1406 (from finding 1014) is +0.1; the likelihood effect 1407 (from finding 1016) is −0.2; the likelihood effect 1408 (from finding 1017) is +0.6;

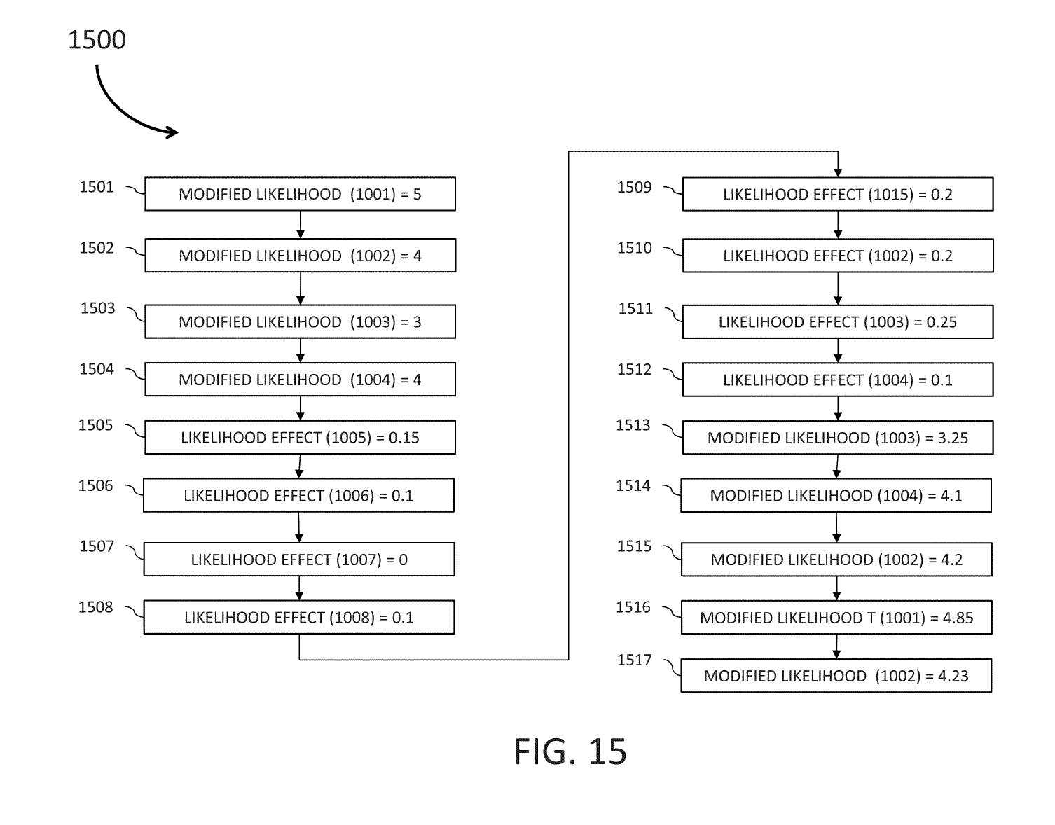

FIG. 15 is a flowchart illustrating steps and resulting computed values of an example calculation of modified likelihood for a potential event, in accordance with some embodiments of the disclosed subject matter. FIG. 15 is based on the exemplary configuration of FIG. 10 which is further elaborated with references to FIGS. 5, 12, 13, 14 and 15.

It is noted that a similar set of drawings to FIGS. 5, 10, 12, 13, 14 and 15 could be produced to illustrate a similar calculation for a different evaluation characteristic of a potential event, for example, calculation of modified impact, with the term ‘likelihood’ replaced by ‘impact’ in the said drawings and associated descriptions herein.

Prior to the calculation of FIG. 15, evaluations are made by a user who inputs the evaluation data of FIGS. 12 and 13, and additionally the findings of FIG. 14 are recorded, in accordance with the disclosed subject matter.

In the explanation below, further reference is made to FIGS. 5, 10, 12, 13, 14 and 15.

Steps 1501-1504 describe a first phase in which fields are initialized. The first phase may be performed in advance of the aggregation calculation.

In step 1501 the computerized apparatus executes step 503 of FIG. 5, using the calculation:
Modified likelihood (1001)=Evaluation likelihood (1001)
Modified likelihood (1001)=5

In step 1502, the computerized apparatus executes step 503 of FIG. 5, using the calculation:
Modified likelihood (1002)=Evaluation likelihood (1002)
Modified likelihood (1002)=4

In step 1503, the computerized apparatus executes step 503 of FIG. 5, using the calculation:
Modified likelihood (1003)=Evaluation likelihood (1003)
Modified likelihood (1003)=3

In step 1504, the computerized apparatus executes step 503 of FIG. 5, using the calculation:
Modified likelihood (1004)=Evaluation likelihood (1004)
Modified likelihood (1004)=4

Steps 1505-1509 describe aggregation phase I, calculation of an aggregated likelihood effect of controls related to potential events:

In step 1505, the computerized apparatus executes step 504 of FIG. 5, containing step 603 of FIG. 6, comprising of the calculation:

Likelihood effect(1005)=Average((Likelihood effect(1009), Likelihood effect(1010))
AGGREGATED LIKELIHOOD EFFECT=AVG(LIKELIHOOD EFFECT FROM FINDINGS)
Likelihood effect(1005)=Avg(0.1, 0.2)
Likelihood effect(1005)=0.15

In step 1506, the computerized apparatus executes step 504 of FIG. 5, containing step 603 of FIG. 6, comprising of the calculation:
AGGREGATED LIKELIHOOD EFFECT=AVG(LIKELIHOOD EFFECT FROM FINDINGS)
Likelihood effect(1006)=Average(Likelihood effect(1011))
Likelihood effect(1006)=Avg(0.1)
Likelihood effect(1006)=0.1

In step 1507, the computerized apparatus executes step 504 of FIG. 5, containing step 603 of FIG. 6, comprising of the calculation:

Likelihood effect(1007)=Average(no findings)
AGGREGATED LIKELIHOOD EFFECT=AVG(LIKELIHOOD EFFECT FROM FINDINGS)
Likelihood effect(1007)=Avg(0)
Likelihood effect(1007)=0

In step 1508, the computerized apparatus executes step 504 of FIG. 5, containing step 603 of FIG. 6, comprising of the calculation:

Likelihood effect(1508)=Average((Likelihood effect(1012), Likelihood effect(1013), Likelihood effect(1014))
AGGREGATED LIKELIHOOD EFFECT=AVG(LIKELIHOOD EFFECT FROM FINDINGS)
Likelihood effect(1008)=Avg(−0.1, 0.3, 0.1)
Likelihood effect(1008)=0.1

In step 1509, the computerized apparatus executes step 504 of FIG. 5, containing step 603 of FIG. 6, comprising of the calculation:
AGGREGATED LIKELIHOOD EFFECT=AVG(LIKELIHOOD EFFECT FROM FINDINGS)
Likelihood effect(1015)=Average((Likelihood effect(1016), Likelihood effect(1017))
Likelihood effect(1015)=Avg(−0.2, 0.6)
Likelihood effect(1015)=0.2

Steps 1510-1512 describe a second phase, during which aggregation is performed. The aggregation phase may include calculation of an aggregated effect on the likelihood of each potential event from the aggregated likelihood effect of related controls:

In step 1510, the computerized apparatus executes step 505 of FIG. 5, containing step 703 of FIG. 7, comprising of the calculation:
AGGREGATED LIKELIHOOD EFFECT=Σ(LIKELIHOOD EFFECT FROM CONTROLS)
Likelihood effect(1002)=Likelihood effect(1015)
Likelihood effect(1002)=0.2

In step 1511, the computerized apparatus executes step 505 of FIG. 5, containing step 703 of FIG. 7, comprising of the calculation:
AGGREGATED LIKELIHOOD EFFECT=Σ(LIKELIHOOD EFFECT FROM CONTROLS
Likelihood effect(1003)=Likelihood effect(1005)+Likelihood effect(1006)
Likelihood effect(1003)=0.15+0.1
Likelihood effect(1003)=0.25

In step 1512, the computerized apparatus executes step 505 of FIG. 5, containing step 703 of FIG. 7, comprising of the calculation:
AGGREGATED LIKELIHOOD EFFECT=Σ(LIKELIHOOD EFFECT FROM CONTROLS
Likelihood effect(1004)=Likelihood effect(1007)+Likelihood effect(1008)
Likelihood effect(1004)=0+0.1
Likelihood effect(1004)=0.1

Steps 1513-1515 describe a third phase, which also includes aggregation. The third phase calculates a modified likelihood for each potential event based on the aggregated effect on the likelihood of the potential event from the aggregated effect of related controls, calculated in previous steps:

In step 1513, the computerized apparatus executes step 506 of FIG. 5, using the method of FIG. 8, comprising of the calculation:
MODIFIED LIKELIHOOD=EVALUATION LIKELIHOOD+AGGREGATED LIKELIHOOD EFFECT
Modified likelihood (1003)=Evaluation likelihood (1003)+Likelihood effect(1003)
Modified likelihood (1003)=3+0.25
Modified likelihood (1003)=3.25

In step 1514, the computerized apparatus executes step 506 of FIG. 5, using the method of FIG. 8, comprising of the calculation:
MODIFIED LIKELIHOOD=EVALUATION LIKELIHOOD+AGGREGATED LIKELIHOOD EFFECT
Modified likelihood (1004)=Evaluation likelihood (1004)+Likelihood effect(1004)
Modified likelihood (1004)=4+0.1
Modified likelihood (1004)=4.1

In step 1515, the computerized apparatus executes step 506 of FIG. 5, using the method of FIG. 8, comprising of the calculation:

### MODIFIED LIKELIHOOD=EVALUATION LIKELIHOOD+AGGREGATED LIKELIHOOD EFFECT

Modified likelihood (1002)=Evaluation likelihood (1002)+Likelihood effect(1002)
Modified likelihood (1002)=4+0.2
Modified likelihood (1002)=4.2

Steps 1516-1517 describe a fourth phase. The fourth phase comprises calculation of a modification to likelihood of potential events that are affected by other potential events which may or may not have been modified in a previous step:

In step 1516, the computerized apparatus executes step 507 of FIG. 5, incorporating the method of FIG. 9, which computes a modified likelihood for potential event 1001. Potential event Potential event 1001 is affected by one other potential event 1003, therefore:
Modified likelihood of potential event 1001=
Evaluation likelihood of potential event 1001 (5)
+(Modified likelihood of affecting potential event 1003 (3.25)
−evaluation likelihood of affecting potential event 1003 (3))
/number of values in likelihood sequence (5)
*likelihood effect of potential event 1003 on potential event 1001 (−3)

Therefore:
Modified likelihood of potential event 1001=5+(3.25−3)/5*−3
Modified likelihood of potential event 1001=4.85

In step 1517, the computerized apparatus executes step 507 of FIG. 5, incorporating the method of FIG. 9, which computes a modified likelihood for potential event 1002. Potential event 1002 is affected by two other potential events 1003 and 1004. Additionally, a modified likelihood has been computed for potential event 1002 in step 1515, from its controls, therefore:
Modified likelihood of potential event 1002=
Modified likelihood of potential event 1002 (4.2)
+
(
(Modified likelihood of affecting potential event 1003 (3.25)
−evaluation likelihood of affecting potential event 1003 (3))
/number of values in likelihood sequence (5)
*likelihood effect of potential event 1003 on potential event 1002 (1)
)+
(
(Modified likelihood of affecting potential event 1004 (4.1)
−evaluation likelihood of affecting potential event 1004 (4))
/number of values in likelihood sequence (5)
*likelihood effect of potential event 1004 on potential event 1002 (−1)
)
Modified likelihood of potential event 1002=4.2+(3.25−3)/5*1+(4.1−4)/5*−1
Modified likelihood of potential event 1002=4.2+0.05−0.02=4.23

It is noted that FIGS. 5-15 and the detailed descriptions herein refer to an exemplary embodiment of a method of modifying likelihood of potential events and an equivalent method can be used for the modification of other properties of potential events, for example impact, replacing the term likelihood with impact.

FIG. 16 is a flowchart of a process for notifying users of upcoming control monitoring tasks, in accordance with some embodiments of the disclosed subject matter. In some exemplary embodiments, the steps of FIG. 16 may be performed as part of step 106 of FIG. 1.

In step 1601, the computerized apparatus identifies scheduled control monitoring tasks that are scheduled to be executed in a predefined timeframe such as the following week.

In step 1602, the computerized apparatus identifies the users who have been assigned to perform the control monitoring task and associates them with each selected monitoring task.

In step 1603, the computerized apparatus sorts the control monitoring tasks by user. The computerized apparatus may identify the monitoring task descriptions and the user destination email addresses, telephone numbers and other contact information that can be used to issue notifications to users of monitoring tasks.

In step 1604, the computerized apparatus issues notifications to users, containing details of required scheduled monitoring tasks, to a computerized output device, based on the information identified and sorted in steps 1601-1603. The means of notification may include but will not be limited to; the sending of an email message to one or more email addresses specified for the user, via an email server configured to receive requests from the computerized apparatus and configured to send those requests to the destination email address; the sending of a Short Message Service (SMS) message or other form of text message via a third party text messaging service using an Application Programming Interface (API) or the like. In some cases any other method that is configured to receive requests from the computerized apparatus and send those requests to a destination device, such as a phone identified by a phone number may be used. Some methods may include displaying of a message on the screen of the computerized apparatus when the user logs in, or at any other time. In some exemplary embodiments, a pop-up alert message may be provided to a device of a user to notify the user.

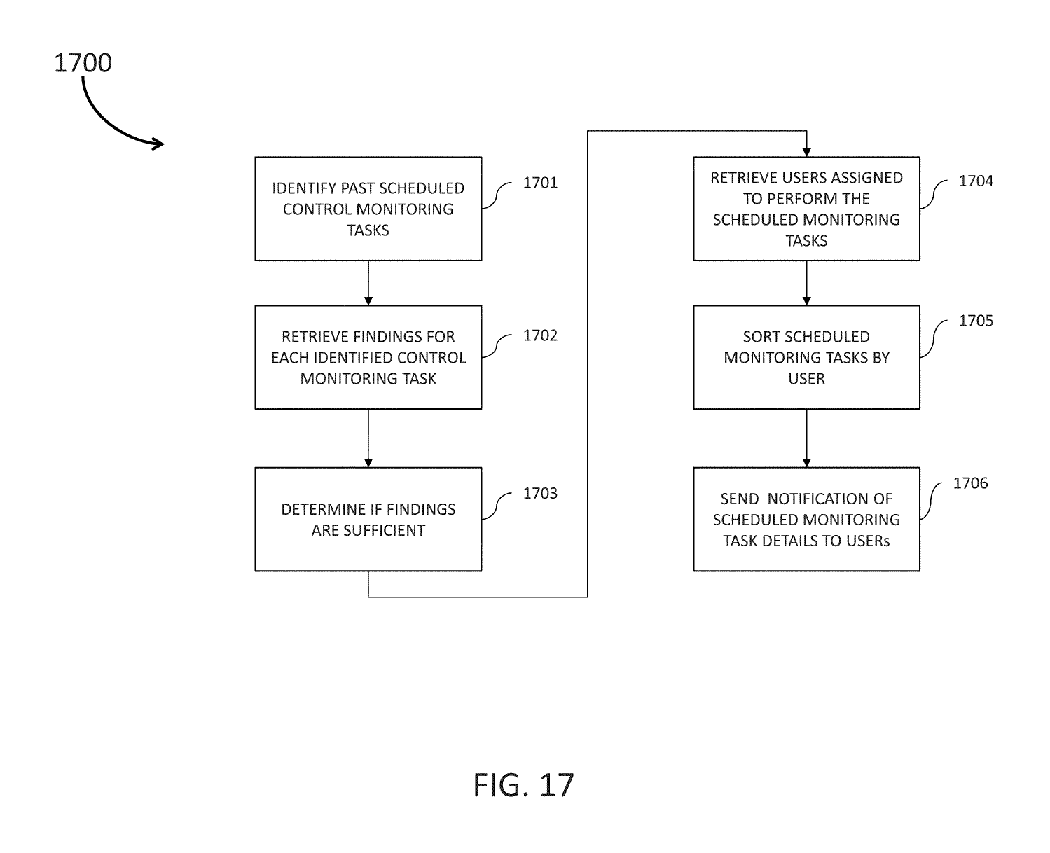

FIG. 17 is a flowchart of a process for notifying users of uncompleted control monitoring tasks, in accordance with some embodiments of the disclosed subject matter. In some exemplary embodiments, the steps of FIG. 17 may be performed as part of step 106 of FIG. 1.

In step 1701, the computerized apparatus identifies scheduled control monitoring tasks whose scheduled date has passed.

In step 1702, the computerized apparatus retrieves findings for each of the control monitoring tasks identified in step 1701.

In step 1703, the computerized apparatus compares requirements for findings with actual findings for each control monitoring task, and identifies uncompleted tasks. In some embodiments, a control may be defined as requiring a minimal number of findings.

Additionally or alternatively, a control may be defined with requirements for findings such as the inclusion of resources with certain characteristics, e.g. specific resources, resources associated with specified resource groups, resources associated with specified organizational units or any other characteristics of findings.

In step 1704, the computerized apparatus retrieves users who were assigned to perform each of the uncompleted control monitoring tasks.

In step 1705, the computerized apparatus sorts the control monitoring tasks by user.

In step 1706, the computerized apparatus issues notifications to all assigned users, containing details of the uncompleted scheduled monitoring tasks, to a computerized output device. The means of notification employed in step 1706 may be the same or similar to those described in step 1604 of FIG. 16.

FIG. 18 is a flowchart of a potential event history report, in accordance with some embodiments of the disclosed subject matter. In some exemplary embodiments, the steps of FIG. 18 may be performed as part of step 106 of FIG. 1.

In step 1801, the computerized apparatus receives a potential event. In some cases, the potential event may be a potential event for which a history report is required or desired.

In step 1802, the computerized apparatus retrieves historical evaluation data, which is evaluation data such as evaluation likelihood and evaluation impact, that has since been replaced by a user, with newer evaluations, such as when re-evaluating the potential events. The process of replacing evaluation data may be a part of the process of step 203 of FIG. 2, described herein.

In step 1803, the computerized apparatus retrieves controls defined for the potential event.

In step 1804, the computerized apparatus retrieves findings received for the potential event.

In step 1805, the computerized apparatus sorts previous evaluations, control additions and changes and findings, by date and time.

In step 1806, the computerized apparatus computes aggregated values for the potential event. These may be displayed as a ‘current status’ or ‘summary’ for the report. Some embodiments may employ aggregation of the contained evaluations, control additions, changes and findings and may calculate modified likelihood, and modified impact for the potential event. In some embodiments, this aggregation may employ part of the process of FIG. 5.

In step 1807, the computerized apparatus outputs the sorted data, to a computerized output device. One embodiment of the output data is illustrated in FIG. 31 and the description herein. The embodiment of FIG. 31 is one variant of a textual table report. Other embodiments may take the form of textual reports in alternative formats, graphs, Gantt charts, timelines with balloons and the like.

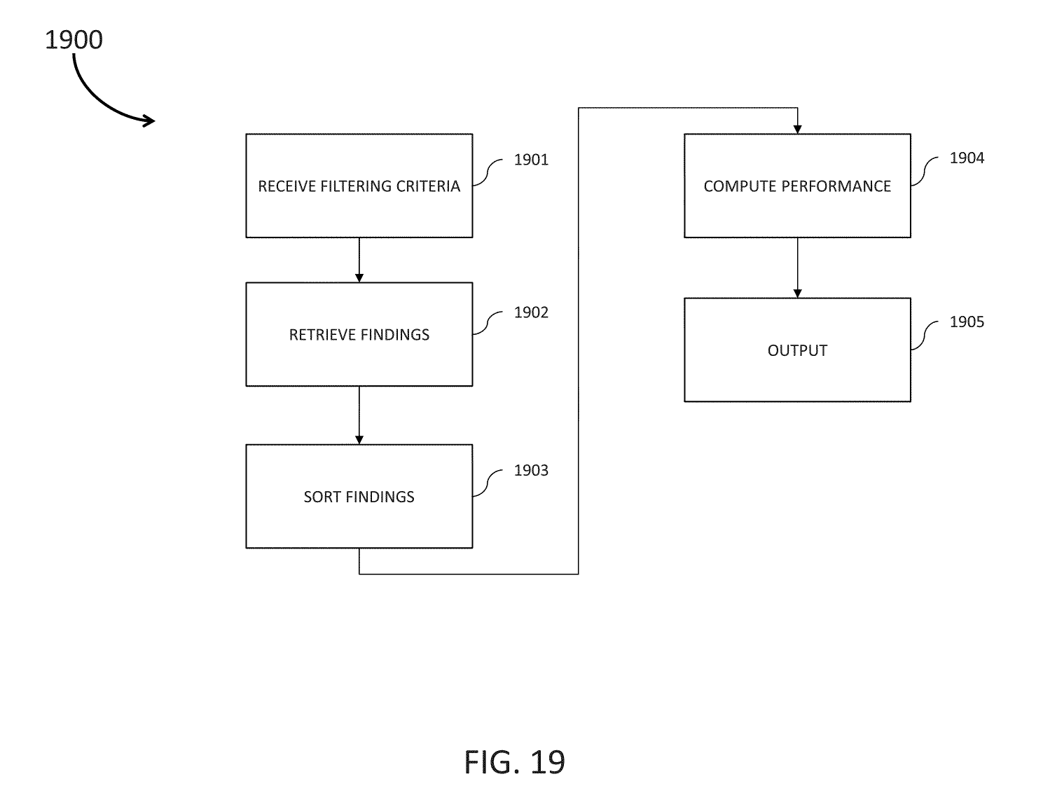

FIG. 19 is a flowchart of a findings report, in accordance with some embodiments of the disclosed subject matter. In some exemplary embodiments, the steps of FIG. 19 may be performed as part of step 106 of FIG. 1.

In step 1901, the computerized apparatus receives filtering criteria.

In step 1902, the computerized apparatus retrieves previously recorded findings, according to the filtering criteria received in step 1901.

In step 1903, the computerized apparatus sorts the retrieved findings into a sequence that may be convenient to a user, e.g. by date, user, associated resource, associated organizational unit or other characteristic, or a combination of these.

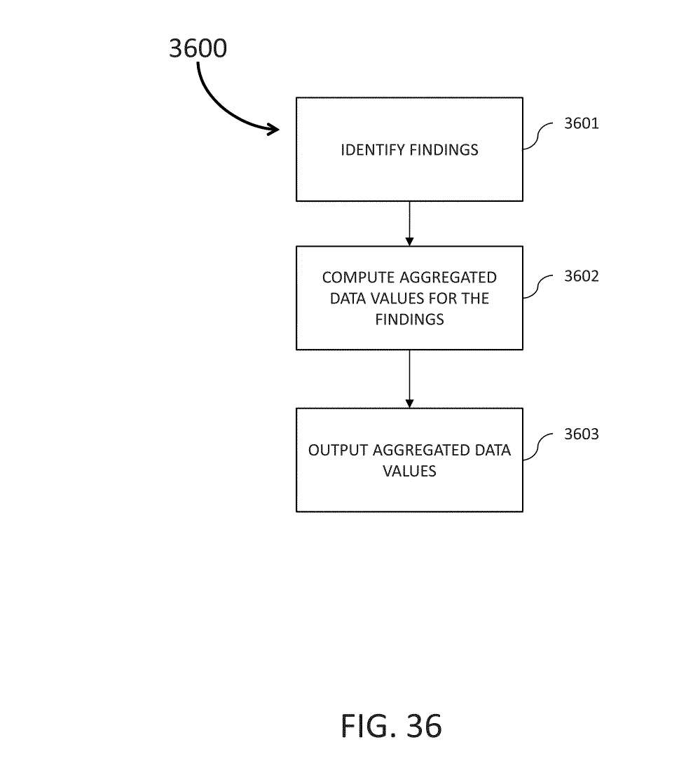

In step 1904, the computerized apparatus optionally computes performance of one or more subsets of the sorted retrieved findings from step 1903. Such computations may be achieved by executing a method such as that of FIG. 36 for one or more subsets of the retrieved findings.

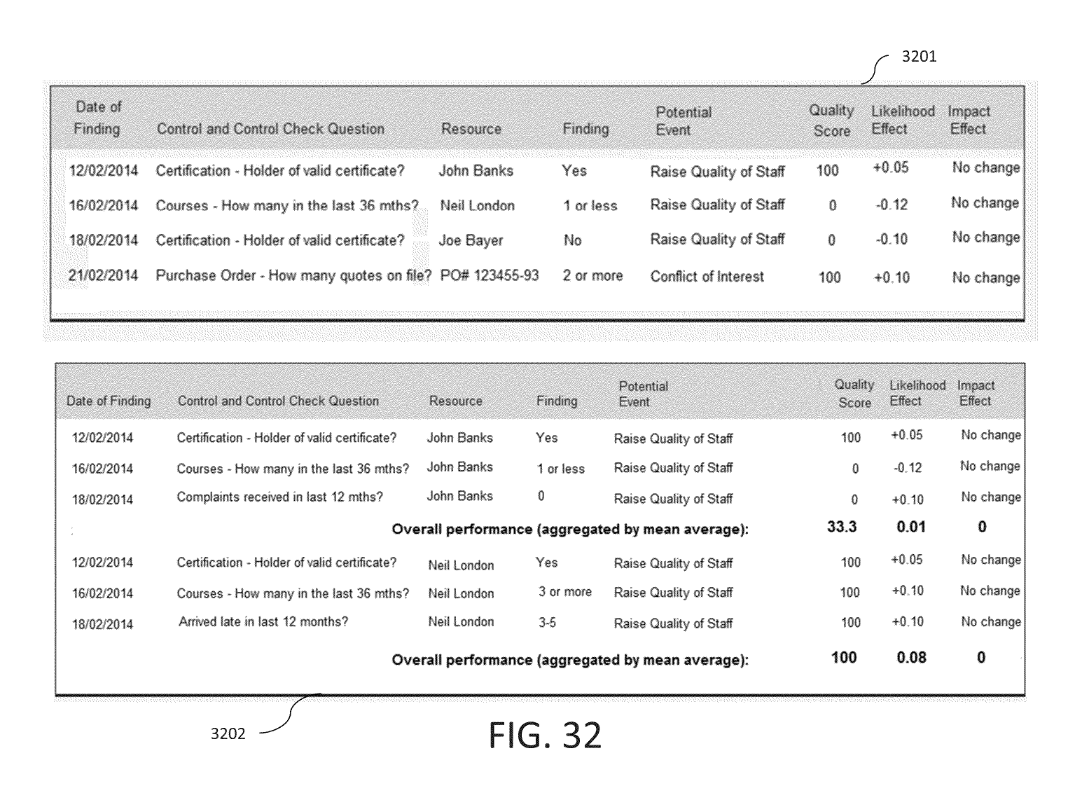

In step 1905, the computerized apparatus outputs the findings to a computerized output device. Mockup screens for two exemplary embodiments of the output data are illustrated in FIG. 32 and the description herein. Mockup Screen 3201 is an example of output without the inclusion of aggregated performance data and mockup screen 3202 is an example of output including performance data derived from the process of step 1904. The embodiment of FIG. 32 is one variant of a textual table report. Other embodiments may take the form of textual reports in alternative formats, graphs, timelines with balloons and the like.

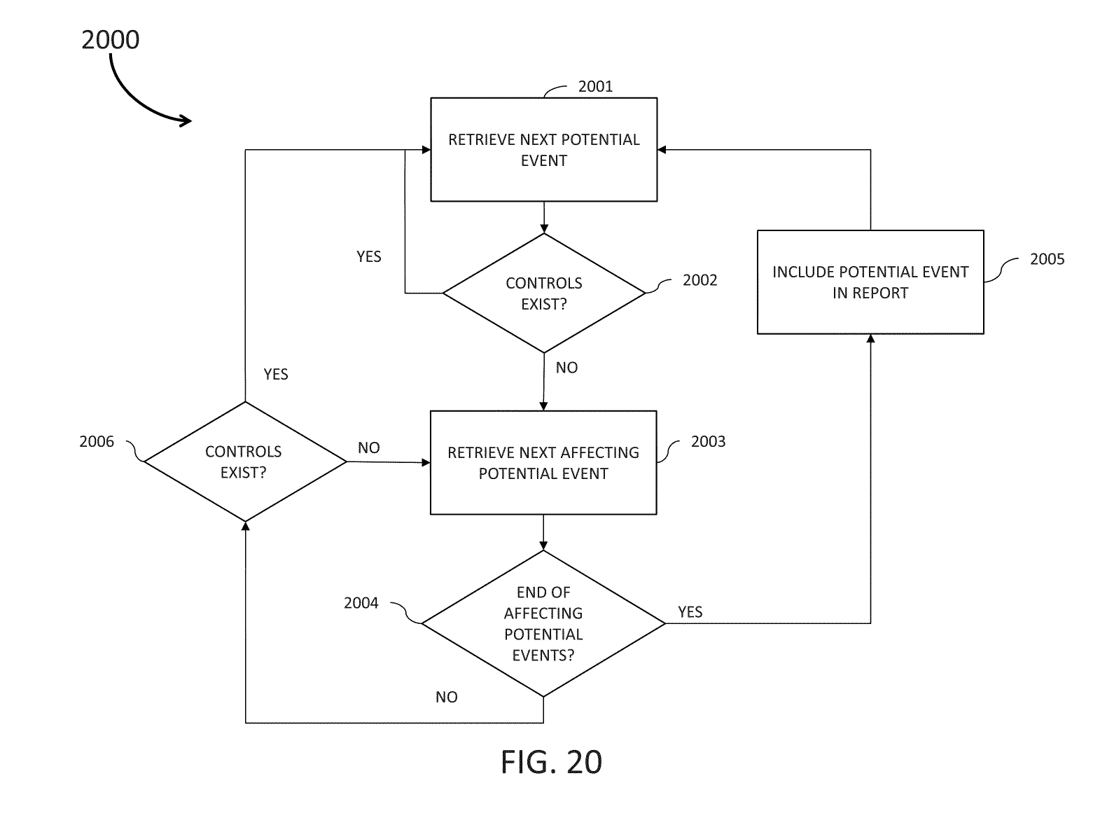

FIG. 20 is a flowchart of an algorithm for reporting potential events without controls, in accordance with some embodiments of the disclosed subject matter. In some exemplary embodiments, the steps of FIG. 20 may be performed as part of step 106 of FIG. 1.

In step 2001, the computerized apparatus retrieves the next potential event.

In step 2002, the computerized apparatus checks whether at least one control exists for the currently selected potential event. If YES, the currently selected potential event from 2001 is not included in the required population and the process continues at step 2001. If NO, the process continues at step 2003.

In step 2003, the computerized apparatus retrieves the next potential event that is configured as affecting the current potential event, directly or indirectly.

In step 2004, the computerized apparatus checks for end of affecting potential events. If YES, the process continues at step 2005. If no, the process continues at step 2006.

In step 2005, the computerized apparatus includes the current potential event, from 2001, in the report then continues at step 2001.

In step 2006, the computerized apparatus checks whether at least one control exists for the currently selected affecting potential event from 2003. If YES, the currently selected potential event from 2001 is not included in the required population and the process continues at step 2001. If NO, the process continues at step 2003.

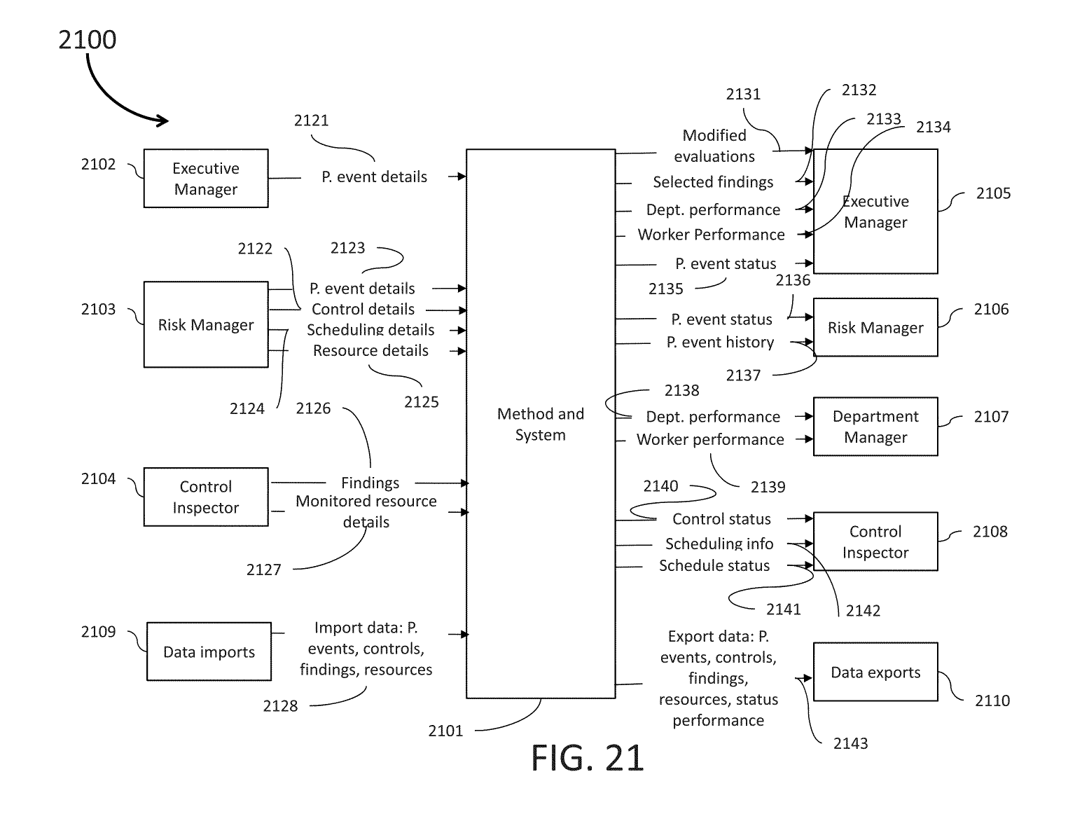

FIG. 21 is an external I/O diagram, in accordance with some embodiments of the disclosed subject matter. FIG. 21 illustrates the external sources of input data and the type of data that passes from those external sources to the system, and further illustrates the external destinations of information produced by the system in processing the input data and the type of data that passes from the system to those external destinations.

The inputs to and outputs from the system [2101] may be manual, through human entry on computer screens, mobile devices or similar types of entry, and/or may be executed through automated means such as file imports, Electronic Data Interchange (EDI) and the like.

Executive managers [2102], who may be board members, owners or stakeholders, input details of strategic potential events such as objectives [2121]. In practice, it may be the risk manager [2103] who enters the data [2121] into the system, but the source of such organizational objectives is considered as emanating from the executive managers [2102].

The risk manager [2103] may be an individual dedicated to the task of risk management, or may be any other senior or responsible individual who has sufficient knowledge of the organization, its objectives, risks and activity to specify risk-type potential event details [2123], details of the controls [2122] that have been or are to be implemented and these details [2122] include evaluations. Additional responsibilities of the risk manager may be the planning of control monitoring activity and entering this information in the form of scheduling details [2124] and entering resource details [2125] manually and/or by initiating an import process.

The control inspector [2104], who may be a manager, a responsible employee, external service provider or other suitable individual, inputs the findings [2126] of control monitoring activity, together with the details of the resource [2127] that participated in the observed (monitored) activity.

Many of the aforementioned inputs may be input into the system by automated means and so for completeness, data imports [2109] is specified as a source in itself from which import data [2128] comprising potential events, controls, findings, resources and other relevant data enter the system.

Moving now to the system's outputs, the emphasis is placed on the main categories of processed information, rather than specific formats or reports, which can be wide ranging.

The executive manager [2105] is a consumer for modified evaluations [2131], selected findings [2132], department performance [2133], which is a subset of findings, worker performance data [2134], which is a subset of findings and potential event status [2135], all of which may be delivered in the form of reports, scorecards, dashboards or other forms of output. Potential event status [2135] comprises the wealth of information that the system can provide from an overall picture of the potential events in the organization down to the history of one specific potential event, including such information as evaluations, controls introduced and monitoring of findings.

The risk manager [2106] receives potential event status information[2136] and potential event history [2137], which, although contained in potential event status [2136], may be provided separately to assist the risk manager in performing his or her responsibilities.

Department managers [2107] receive department performance [2138] and worker performance [2139], both subsets of selected findings, providing them with management control information.

The control inspector [2108] may receive certain information from the system to know what control monitoring activity needs to be done before he/she can input findings and related information to the system. This information comprises schedule status [2141], which constitutes the schedules that contain controls appropriate for the inspector, scheduling info [2142], which specifies the controls that are scheduled and on the task list of the control inspector [2108] and the control status [2140], which contains all the information about specific scheduled controls, needed by the inspector to decide if and how to monitor the control in question, also including notifications such as notification of upcoming or incomplete tasks.

Many of the aforementioned outputs and additional outputs may be output from the system to computer-readable media and so for completeness, data exports [2110] has been denoted as an entity consuming information created in the system. The export data [2143] that flows to the data exports [2110] is varied and comprises both ‘raw data’ such as potential events and controls but also processed information such as statuses and performance.

FIG. 22 is a mockup of a screen for configuring organizational structure, in accordance with some embodiments of the disclosed subject matter. FIG. 22 shows on the left side a tree structure of an organizational structure that has been defined by a user and on the right side an input form for specifying the details of one organizational unit. In some exemplary embodiments, the screen of FIG. 22 may be a part of step 201 of FIG. 2.

FIG. 23 is a mockup of a screen for configuring resources and resource groups, in accordance with some embodiments of the disclosed subject matter. FIG. 23 shows in the left column a list of resources that have been defined by a user, in the center column a list of resource groups that have been defined by a user and on the right side an input form for specifying the details of one resource. In some exemplary embodiments, the screen of FIG. 23 may be a part of step 202 of FIG. 2.

FIG. 24 is a mockup of a screen for configuring potential events, in accordance with some embodiments of the disclosed subject matter. FIG. 24 shows on the left side a list of potential events that have been defined by a user and on the right side a form displaying evaluation data. At the top right appear current evaluation likelihood, current evaluation impact, acceptable evaluation likelihood and acceptable evaluation impact and at the bottom appears a list of other potential events which affect the currently selected potential event, showing for each of the affecting potential events, a likelihood effect and an impact effect. Additionally or alternatively, a list (not shown) of other potential events which are affected by the currently selected event may be displayed. The list may show for each of the affected potential events a likelihood effect and an impact effect. In some exemplary embodiments, the screen of FIG. 24 may be a part of step 203 of FIG. 2, as depicted in the description of step 203 of FIG. 2.

FIG. 25 is a mockup of a screen for configuring controls, in accordance with some embodiments of the disclosed subject matter. FIG. 25 shows on the left side a list of potential events, control groups and controls that have been defined by a user and, on the right side, an input form for specifying the details of one control, defining a control monitoring task that can be performed by a user. The monitoring details include resource groups that specify the possible resources participating in the monitored control, a control check question that will be presented to the user, and potential findings resulting from the observation. Each potential finding contains likelihood effect, impact effect and quality score. Additional potential findings may be added as can be seen in the Add Value button. In some exemplary embodiments, the screen of FIG. 25 may be a part of step 204 of FIG. 2 as depicted in the description of step 204 of FIG. 2.

FIG. 26 is a mockup of a screen for defining a schedule, in accordance with some embodiments of the disclosed subject matter. FIG. 26 shows on the left side a calendar-like display of controls scheduled to be executed; in the center, a list of controls that have been defined by a user and which can be assigned to the appropriate date in the calendar, for example by a drag and drop operation. FIG. 26 shows on the right side an input form specifying information describing the schedule. In some exemplary embodiments, the screen of FIG. 26 may be a part of step 301 of FIG. 3.

FIG. 27 is a mockup of a screen for selecting a schedule, as a preliminary step before entering findings, in accordance with some embodiments of the disclosed subject matter. FIG. 27 shows a list of available schedules. In some exemplary embodiments, the screen of FIG. 27 may be a part of steps 401 and 402 of FIG. 4.

FIG. 28 is a mockup of a screen for selecting a control, as a preliminary step before entering findings, in accordance with some embodiments of the disclosed subject matter. FIG. 28 shows a list of scheduled controls. In some exemplary embodiments, the screen of FIG. 28 may be a part of steps 403 and 404 of FIG. 4.

FIG. 29 is a mockup of a screen displaying findings entered previously in the system, in accordance with some embodiments of the disclosed subject matter. The displayed findings can be edited by clicking on the edit icon for the finding, and a new finding can be entered by clicking on the ‘New Finding’ button. In some exemplary embodiments, the screen of FIG. 29 may be a part of steps 405 and 406 of FIG. 4.

FIG. 30 is a mockup of a screen for entering findings, in accordance with some embodiments of the disclosed subject matter. FIG. 30 illustrates the selection of a resource group, selection of a resource from the selected group, the control question the answer to which will constitute the finding and selection of potential findings, a selection of the answer to the control question from a list of potential answers. In some exemplary embodiments, the screen of FIG. 30 may be a part of steps 406, 407, 408, 409 and 410 of FIG. 4.

FIG. 31 is a mockup of a potential event history report, in accordance with some embodiments of the disclosed subject matter. In some exemplary embodiments, the process of producing the report of FIG. 31 may be performed as part of FIG. 18. In some exemplary embodiments, the process of producing the report of FIG. 31 may be performed as part of step 106 of FIG. 1. FIG. 31 illustrates a table report consisting of chronological events pertaining to a potential event, including date, description and evaluation data, the evaluation data consisting of current likelihood, acceptable likelihood, current impact and acceptable impact. FIG. 31 illustrates some chronological events pertaining to the potential event entitled “Theft of Corporate Data”.

The first chronological event, from the top, dated 14 Jan. 2014 and entitled ‘Potential event defined . . . ’, describes the creation of the potential event. In some exemplary embodiments, the chronological event entitled ‘Potential event defined’ may be performed as part of step 203 of FIG. 2, which is further illustrated in FIG. 24. The values for current likelihood, acceptable likelihood, current impact and acceptable impact indicate the evaluation data provided by the user when the potential event record was created.

The second chronological event, from the top, dated 14 Jan. 2014 and entitled ‘Control added’ describes the addition of a control entitled ‘Check computer room door’. In some exemplary embodiments, the chronological event entitled ‘Control added’ may be performed as part of step 204 of FIG. 2, which is further illustrated in FIG. 25. The text ‘N/A’ (meaning not applicable) appears in all of the 4 evaluation data fields and indicates that they cannot be affected by the chronological event ‘Control added’.

The third chronological event from the top, dated 19 Jan. 2014 and entitled ‘Control monitored’, describes the receiving of a finding for the control ‘Check computer room door’. In some exemplary embodiments, the chronological event entitled ‘Control monitored’ may be performed as part of step 410 of FIG. 4, which is further illustrated in FIG. 30. The chronological event contains a description comprising the control name, control check question, the finding and the quality score. The current likelihood and current impact columns for the control monitoring history event contain the likelihood effect and impact effect resulting from selected finding, which is the defined in the definition of potential findings in the control as illustrated in FIG. 25. In this particular example, the finding does not change the current likelihood or current impact, and an appropriate indication is provided in the report. The text ‘N/A’ (meaning not applicable) appears in the acceptable likelihood and acceptable impact fields to indicate that these are not applicable to the control monitoring history event.

The forth chronological event from the top, dated 25 Jan. 2014 and entitled Re-evaluation refers to a change in one or more of the 4 evaluation fields for the potential event, by a user. In some exemplary embodiments, the chronological event entitled ‘Re-evaluation’ may be performed as part of step 203 of FIG. 2, which is further illustrated in FIG. 24. The values for current likelihood, acceptable likelihood, current impact and acceptable impact indicate the evaluation data provided by the user when the potential event record was changed. One of these evaluation data fields, acceptable likelihood has been changed from 1—Low to 2—Low/Med and the other evaluation data fields are unchanged.

The fifth chronological event from the top, dated 31 Jan. 2014 describes the receiving of an additional finding for the control ‘Check computer room door’, similar to that described above for the third chronological event from the top. In this case, the finding has a likelihood effect of +1.00 and an impact effect of ‘No change’.

At the bottom of the report, the current status line displays the likelihood and impact following the effect of the chronological events appearing in the report. Current likelihood is the result of aggregation of the findings for the potential event, based on the evaluated likelihood value of 3—Med and adjusted by the likelihood effect of +1.00, resulting in 4—Med/High; Acceptable likelihood corresponds to the last re-evaluation, which was 2—Low/Med. Current impact and acceptable impact remain unchanged since the creation of the potential event, at 3—Mild. In some embodiments, the likelihood and impact of current status line may be computed using the methods of FIGS. 8 and 9. In some embodiments, the likelihood and impact on current status line may be termed modified likelihood and modified impact.

FIG. 32 is a mockup of a findings report, in accordance with some embodiments of the disclosed subject matter. In some exemplary embodiments, the process of producing the report of FIG. 32 may be performed as part of FIG. 19. In some exemplary embodiments, the process of producing the report of FIG. 32 may be performed as part of step 106 of FIG. 1. FIG. 32 illustrates a table report consisting of some findings. Each finding may have been recorded as part of step 410 of FIG. 4. The findings displayed may have been filtered following the specification of filtering criteria by a user. The information displayed for each finding comprises the date on which the finding was attained, the name of the control for which the finding was recorded, the check question presented to the user to which the user was expected to select the most suitable finding, the resource involved in the observation, the finding selected, the potential event for which the finding was recorded and the evaluation data associated with the selected finding, including quality score, likelihood effect and impact effect. Mockup Screen 3201 is an example of output without the inclusion of aggregated performance data. The report displays data from the findings and from associated data items including controls, potential events and resource name and the finding values assigned by the user when recording the finding—quality score, likelihood effect and impact effect.

Mockup screen 3202 is an example of a report including data similar to that seen in mockup screen 3201, with the addition of performance data derived from the process of step 1904 of FIG. 19. It can be observed in screen 3202 that the displayed findings are sorted by resource and on change of resource, an aggregated summary line is displayed with aggregated values for quality score, validation effect and validation likelihood.

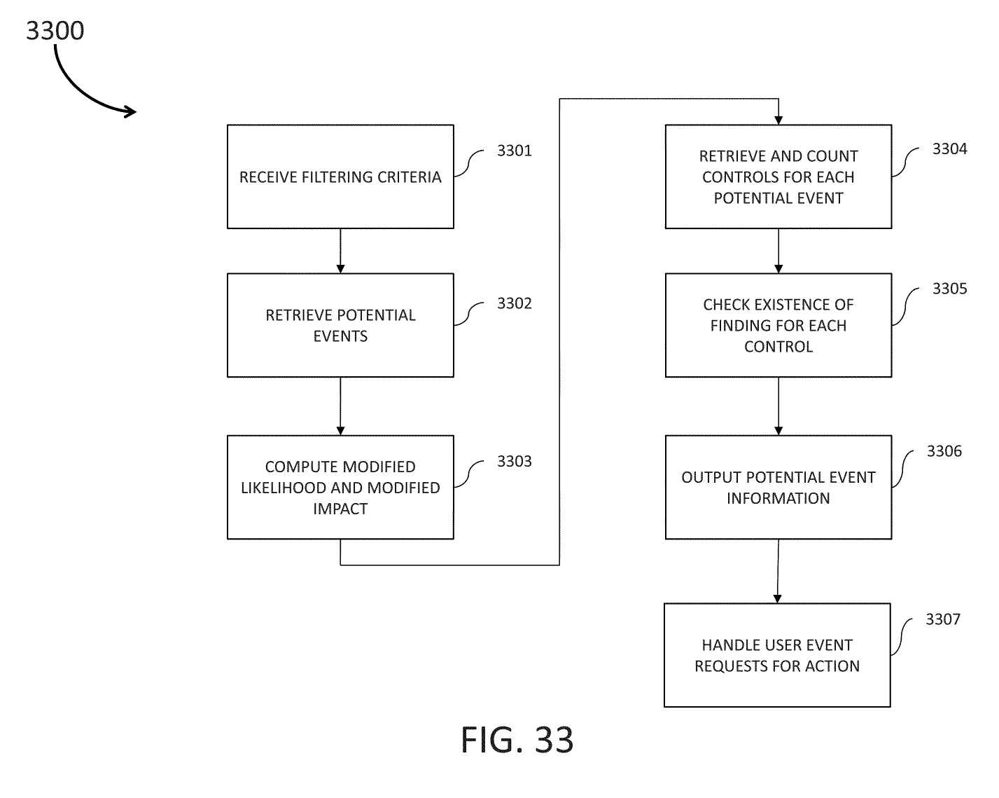

FIG. 33 is a flowchart of a potential event status report, in accordance with some embodiments of the disclosed subject matter. In some exemplary embodiments, the steps of FIG. 33 may be performed as part of step 106 of FIG. 1.

In step 3301, the computerized apparatus receives filtering criteria required.

In step 3302, the computerized apparatus retrieves potential events, according to the filtering criteria received in step 3301.

In step 3303, the computerized apparatus computes a modified likelihood and modified impact for each potential event identified in step 3302. In some exemplary embodiments, step 3303 may perform the said computation as part of the process of FIG. 5.

In step 3304, the computerized apparatus identifies any controls defined for each potential event identified in step 3302 and keeps a count of the number of controls identified.

In step 3305, for each control identified in step 3304, the computerized apparatus identifies findings that have been received for the control and keeps a count of the number of controls that have findings. In some embodiments the count may be incremented if at least one finding is identified. In some embodiments, there may be other criteria for incrementing the count, e.g. a minimum number of findings, a required quality score for the findings, and the like.

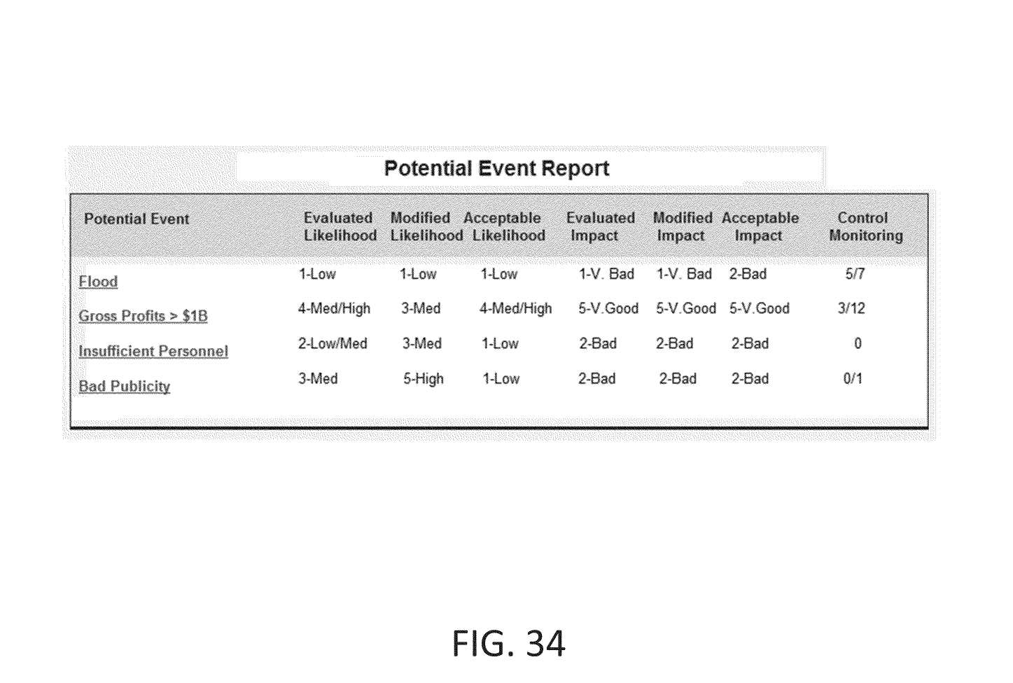

In step 3306, the computerized apparatus outputs the findings to a computerized output device. One embodiment of the output data is illustrated in FIG. 34 and the description herein. The embodiment of FIG. 34 is one variant of a textual table report. Other embodiments may take the form of textual reports in alternative formats, graphs, timelines with balloons and the like.

In step 3307, the computerized apparatus monitors for user requests, such as, for example, viewing more information about a selected potential event, such as, for example the potential event's history. In the embodiment of FIG. 34, a user request may be initiated by a user clicking with a pointing device (e.g., a mouse, a touch screen, or the like) on a potential event name. In case that such a request is initiated by a user, the computerized apparatus responds to the user request accordingly, for example by outputting the potential event history report, illustrated in FIG. 31. In other embodiments, additional or alternative requests for more information or actions concerning the potential events displayed may be provided.

FIG. 34 is a mockup of a potential event status report, in accordance with some embodiments of the disclosed subject matter. In some exemplary embodiments, the process of producing the report of FIG. 34 may be performed as part of FIG. 33. In some exemplary embodiments, the process of producing the report of FIG. 34 may be performed as part of step 106 of FIG. 1. FIG. 34 illustrates a table report consisting of some potential events. Each potential event may have been defined as part of step 203 of FIG. 2. The potential events displayed in FIG. 34 may have been filtered following the specification of filtering criteria by a user. The information displayed for each potential event comprises; the potential event name; an evaluation likelihood, which may have been specified by a user as part of step 203 of FIG. 2; a modified likelihood, which may have been computed as part of FIG. 5; an acceptable likelihood, which may have been specified by a user as part of step 203 of FIG. 2; an evaluation impact, which may have been specified by a user as part of step 203 of FIG. 2; a modified impact, which may have been computed as part of FIG. 5; an acceptable impact, which may have been specified by a user as part of step 203 of FIG. 2; and control monitoring statistics. The control monitoring statistics comprise of, the number of controls for which findings exist is placed to the left of a diagonal line and the number of controls defined for the potential event placed to its right. In some embodiments a potential event displayed on the output device may be selected by a user, using a computerized input device, e.g. by pointing on the potential event name with a pointing device. In some embodiments, selection of a potential event displayed on the output device may be done to view more information about the potential event, such as the potential event's history, illustrated in the report of FIG. 31.

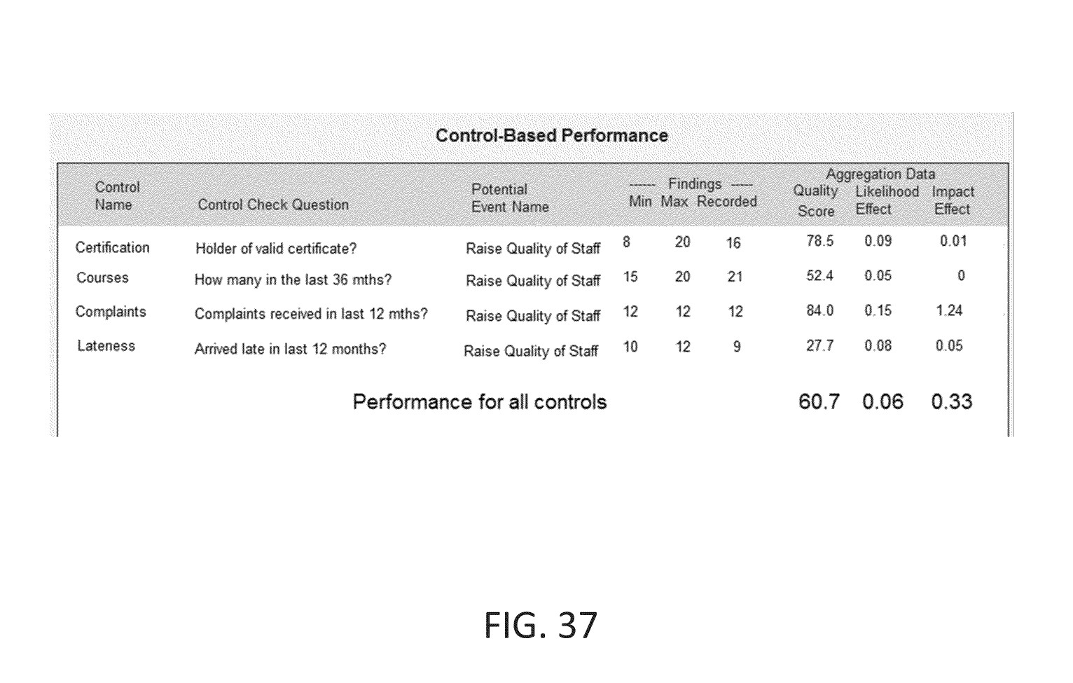

FIG. 35 is a flowchart illustrating a method for calculating performance, based on aggregation of controls, in accordance with some embodiments of the disclosed subject matter. In some exemplary embodiments, the steps of FIG. 35 may be performed as part of a process that produces the report of FIG. 37.

In step 3501, the computerized apparatus receives filtering criteria, which will determine the scope of input data used in the calculation.

In step 3502, the computerized apparatus retrieves a first control answering to the filtering criteria. This step may later be repeated along with the subsequent steps 3503 and 3504.

In step 3503, the computerized apparatus computes one or more aggregated data values for the control, based on its findings. Examples of such data values include likelihood effect, impact effect and quality score. In an embodiment, this computation may be performed using the process of FIG. 6.

In step 3504 the computerized apparatus saves the aggregated data values computed in step 3503.

In step 3505, the computerized apparatus computes further aggregated values from the aggregated data values saved following repetitions of steps 3502-3504. Examples of such aggregated data values include aggregated likelihood effect, aggregated impact effect and aggregated quality score. One embodiment of the aggregation algorithm is a mean average of each the said data values. Other embodiments may use alternative aggregation algorithms, such as but not limited to summation, weighted average, or the like.

In step 3506, the computerized apparatus outputs the aggregated values computed in step 3506 and the aggregated values of steps 3502-3504 to a process or user.

FIG. 36 is a flowchart illustrating a method for calculating performance, based on aggregation of findings, in accordance with some embodiments of the disclosed subject matter:

In step 3601, the computerized apparatus identifies a subset of findings. The subset of findings may have been already identified by another process, such as the findings report of FIG. 19.

In step 3602, the computerized apparatus computes one or more aggregated data values for the subset of findings of step 3601, including for example, likelihood effect, impact effect and quality score. One embodiment of the aggregation algorithm is a mean average of each the said data values. Other embodiments may use alternative aggregation algorithms, such as but not limited to summation, weighted average, or the like.

In step 3603, the computerized apparatus outputs the aggregated values computed in step 3602 to a process or to user.

FIG. 37 is a mockup of a performance report based on the aggregation of controls, in accordance with some embodiments of the disclosed subject matter. In some exemplary embodiments, the process of producing the report of FIG. 37 may be performed as part of step 106 of FIG. 1. The report of FIG. 37 presents one control per line and the displayed values on each line may originate from different sources. Control name, control check question, Min. findings and Max. findings are retrieved from the control; Potential event name is taken from the associated potential event: recorded findings is the number of findings actually recorded by a user and received by the computerized apparatus; and the aggregated quality score, likelihood effect and impact effect are computed values which may have been computed using a method such as that illustrated in FIG. 35. From the minimum, maximum and recorded numbers of findings, and from the descriptions of FIG. 35 and FIG. 6, it can be understood that for the control ‘Certification’, 16 findings participated in the aggregation calculation, for the control ‘Courses’, 20 findings participated, for the control ‘Compliants’, 12 findings participated and for the control ‘Lateness’, the 9 recorded findings participated together with 1 additional finding ‘considered as having been recorded’, as explained in the description of FIG. 6.

The present disclosed subject matter may be implemented as a system, a method, and/or a computer program product. The computer program product may include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the drawings illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the drawings. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description, but is not intended to be exhaustive or limited to the subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

1. A computerized apparatus comprising: a processor, wherein the processor is adapted to perform the steps of:
obtaining potential event specifications defining potential events, wherein a potential event has an evaluation, wherein a potential event specification defines an initial evaluation of a potential event, wherein the potential event specification further defines an effect of different evaluations of a potential event on an evaluation of one or more other potential events;
obtaining control specifications defining controls, wherein a control specification defines potential findings for a control, wherein the control specification defines for each potential finding an effect on an evaluation of one or more potential events;
obtaining findings of performing monitoring of the controls defined by the control specifications;
determining a modified evaluation for each potential event as a modification of the initial evaluation of the potential event, wherein the modified evaluation is based on an aggregated effect of findings and of other potential events on the potential event, in accordance with the potential event specification and the control specification; and
outputting the modified evaluation of the potential events to a user.

2. The computerized apparatus of claim 1, wherein the evaluation of the potential event comprises a likelihood of the potential event occurring and an impact resulting from the occurrence of the potential event.

3. The computerized apparatus of claim 1,
wherein each finding is associated with at least one resource which was monitored as part of the monitoring of the control;
wherein said processor is further adapted to perform: obtaining a set of selected one or more resources;
wherein said determining the modified evaluation for each potential event comprises filtering the findings to the findings that are associated with the set of selected one or more resources; and determining the modified evaluation based on the filtered set of findings and disregarding other findings that are not associated with the set of one or more resources.

4. The computerized apparatus of claim 3, wherein the resources are components that participate in monitoring of the controls, wherein the resources are selected from the group consisting of: people and forms.

5. The computerized apparatus of claim 3, wherein the processor is further adapted to: obtain definitions associating resources with one or more organizational units, wherein said obtaining the set of selected one or more resources comprises obtaining a selected organizational unit and determining, based on the definitions, the resources that are associated with the selected organizational unit.

6. The computerized apparatus of claim 1, wherein said determining the modified evaluation comprises:
computing a first effect of an evaluation of a first finding on the potential event;
computing a second effect of an evaluation of a second finding on the potential event;
aggregating the first and second effect using an aggregated function, wherein the aggregated function is selected from the group consisting of: a minimum function, a maximum function, a weighted average function, a median function, a summation function, a summation function with a diminishing marginal effect, and a combination thereof.

7. The computerized apparatus of claim 1, wherein said determining the modified evaluation comprises:
computing a first effect of an evaluation of a first other potential event on the potential event;
computing a second effect of an evaluation of a second other potential event on the potential event;
aggregating the first and second effect using an aggregated function, wherein the aggregated function is selected from the group consisting of: a minimum function, a maximum function, a weighted average function, a median function, a summation function, a summation function with a diminishing marginal effect, and a combination thereof.

8. The computerized apparatus of claim 1, wherein the processor is further adapted to perform: identifying potential events whose evaluations are not affected, directly or indirectly, by any of the findings; and alerting the user of the identified potential events.

9. The computerized apparatus of claim 1, wherein the monitoring of the controls is performed manually, and wherein said obtaining the findings comprises receiving reports of the performing the monitoring of the controls.

10. The computerized apparatus of claim 1, wherein the monitoring of the controls is performed automatically by a computer, and wherein said obtaining the findings comprises receiving the findings in a computer-readable format.

11. The computerized apparatus of claim 1, wherein the potential event is selected from a group consisting of: a goal, an aim, a risk, an opportunity, a desired state, an undesired state, a desired event and an undesired event.

12. The computerized apparatus of claim 1, wherein the processor is further adapted to perform:
obtaining scheduling specifications defining scheduling of control monitoring, wherein a scheduling specification defines a time on which controls should be monitored;
identifying a missed monitoring of a control based on the scheduling specification and the findings; and
notifying the user of the missed monitoring of the control.

13. The computerized apparatus of claim 1, wherein said control specification further defines for each potential finding an evaluated quality score, wherein evaluated quality score comprises an assessment of a performance resulting in an occurrence of the potential finding.

14. The computerized apparatus of claim 1, wherein the processor is further adapted to perform:
computing an aggregated quality score,
wherein said computing the aggregated quality score comprises:
obtaining an aggregation criterion;
aggregating all findings falling within the aggregation criterion using an aggregation function, wherein the aggregation function is selected from the group consisting of: a minimum function, a maximum function, a weighted average function, a median function, a summation function, a summation function with a diminishing marginal effect, and a combination thereof; and
displaying the aggregated quality score to a user.

15. A method comprising
obtaining potential event specifications defining potential events, wherein a potential event has an evaluation, wherein a potential event specification defines an initial evaluation of a potential event, wherein the potential event specification further defines an effect of different evaluations of a potential event on an evaluation of one or more other potential events;
obtaining control specifications defining controls, wherein a control specification defines potential findings for a control, wherein the control specification defines for each potential finding an effect on an evaluation of one or more potential events;
obtaining findings of performing monitoring of the controls defined by the control specifications;
determining, by a processor, a modified evaluation for each potential event as a modification of the initial evaluation of the potential event, wherein the modified evaluation is based on an aggregated effect of findings and of other potential events on the potential event, in accordance with the potential event specification and the control specification; and
outputting the modified evaluation of the potential events to a user.

16. The method of claim 15, wherein the evaluation of the potential event comprises a likelihood of the potential event occurring and an impact resulting from the occurrence of the potential event.

17. The method of claim 15,
wherein each finding is associated with at least one resource which was monitored as part of the monitoring of the control;
wherein said processor is further adapted to perform: obtaining a set of selected one or more resources;
wherein said determining the modified evaluation for each potential event comprises filtering the findings to the findings that are associated with the set of selected one or more resources; and determining the modified evaluation based on the filtered set of findings and disregarding other findings that are not associated with the set of one or more resources.

18. The method of claim 17, wherein the resources are components that participate in monitoring of the controls, wherein the resources are selected from the group consisting of: people and forms.

19. The method of claim 17 further comprising obtaining definitions associating resources with one or more organizational units, wherein said obtaining the set of selected one or more resources comprises obtaining a selected organizational unit and determining, based on the definitions, the resources that are associated with the selected organizational unit.

20. The method of claim 15, wherein said determining the modified evaluation comprises:
computing a first effect of an evaluation of a first finding on the potential event;
computing a second effect of an evaluation of a second finding on the potential event;
aggregating the first and second effect using an aggregated function, wherein the aggregated function is selected from the group consisting of: a minimum function, a maximum function, a weighted average function, a median function, a summation function, a summation function with a diminishing marginal effect, and a combination thereof.

21. The method of claim 15, wherein said determining the modified evaluation comprises:
computing a first effect of an evaluation of a first other potential event on the potential event;
computing a second effect of an evaluation of a second other potential event on the potential event;
aggregating the first and second effect using an aggregated function, wherein the aggregated function is selected from the group consisting of: a minimum function, a maximum function, a weighted average function, a median function, a summation function, a summation function with a diminishing marginal effect, and a combination thereof.

22. The method of claim 15 further comprising identifying potential events whose evaluations are not affected, directly or indirectly, by any of the findings; and alerting the user of the identified potential events.

23. The method of claim 15, wherein the monitoring of the controls is performed manually, and wherein said obtaining the findings comprises receiving reports of the performing the monitoring of the controls.

24. The method of claim 15, wherein the monitoring of the controls is performed automatically by a computer, and wherein said obtaining the findings comprises receiving the findings in a computer-readable format.

25. The method of claim 15, wherein the potential event is selected from a group consisting of: a goal, an aim, a risk, an opportunity, a desired state, an undesired state, a desired event and an undesired event.

26. The method of claim 15 further comprising:
obtaining scheduling specifications defining scheduling of control monitoring, wherein a scheduling specification defines a time on which controls should be monitored;
identifying a missed monitoring of a control based on the scheduling specification and the findings; and
notifying the user of the missed monitoring of the control.

27. The method of claim 15, wherein said control specification further defines for each potential finding an evaluated quality score, wherein evaluated quality score comprises an assessment of a performance resulting in an occurrence of the potential finding.

28. The method of claim 15, wherein the processor is further adapted to perform:
computing an aggregated quality score,
wherein said computing the aggregated quality score comprises:
obtaining an aggregation criterion;
aggregating all findings falling within the aggregation criterion using an aggregation function, wherein the aggregation function is selected from the group consisting of: a minimum function, a maximum function, a weighted average function, a median function, a summation function, a summation function with a diminishing marginal effect, and a combination thereof; and
displaying the aggregated quality score to a user.

29. A computer program product comprising a computer readable storage medium retaining program instructions, which program instructions when read by a processor, cause the processor to perform a method comprising:
obtaining potential event specifications defining potential events, wherein a potential event has an evaluation, wherein a potential event specification defines an initial evaluation of a potential event, wherein the potential event specification further defines an effect of different evaluations of a potential event on an evaluation of one or more other potential events;
obtaining control specifications defining controls, wherein a control specification defines potential findings for a control, wherein the control specification defines for each potential finding an effect on an evaluation of one or more potential events;
obtaining findings of performing monitoring of the controls defined by the control specifications;
determining a modified evaluation for each potential event as a modification of the initial evaluation of the potential event, wherein the modified evaluation is based on an aggregated effect of findings and of other potential events on the potential event, in accordance with the potential event specification and the control specification; and
outputting the modified evaluation of the potential events to a user.

30. The computer program product of claim 29, wherein the evaluation of the potential event comprises a likelihood of the potential event occurring and an impact resulting from the occurrence of the potential event.

31. The computer program product of claim 29,
wherein each finding is associated with at least one resource which was monitored as part of the monitoring of the control;
wherein said processor is further adapted to perform: obtaining a set of selected one or more resources;
wherein said determining the modified evaluation for each potential event comprises filtering the findings to the findings that are associated with the set of selected one or more resources; and determining the modified evaluation based on the filtered set of findings and disregarding other findings that are not associated with the set of one or more resources.

32. The computer program product of claim 31, wherein the resources are components that participate in monitoring of the controls, wherein the resources are selected from the group consisting of: people and forms.

33. The computer program product of claim 31, wherein the program instructions are further configured to cause the processor to: obtain definitions associating resources with one or more organizational units, wherein said obtaining the set of selected one or more resources comprises obtaining a selected organizational unit and determining, based on the definitions, the resources that are associated with the selected organizational unit.

34. The computer program product of claim 29, wherein said determining the modified evaluation comprises:
computing a first effect of an evaluation of a first finding on the potential event;
computing a second effect of an evaluation of a second finding on the potential event;
aggregating the first and second effect using an aggregated function, wherein the aggregated function is selected from the group consisting of: a minimum function, a maximum function, a weighted average function, a median function, a summation function, a summation function with a diminishing marginal effect, and a combination thereof.

35. The computer program product of claim 29, wherein said determining the modified evaluation comprises:
computing a first effect of an evaluation of a first other potential event on the potential event;
computing a second effect of an evaluation of a second other potential event on the potential event;
aggregating the first and second effect using an aggregated function, wherein the aggregated function is selected from the group consisting of: a minimum function, a maximum function, a weighted average function, a median function, a summation function, a summation function with a diminishing marginal effect, and a combination thereof.

36. The computer program product of claim 29, wherein the processor is further adapted to perform: identifying potential events whose evaluations are not affected, directly or indirectly, by any of the findings; and alerting the user of the identified potential events.

37. The computer program product of claim 29, wherein the monitoring of the controls is performed manually, and wherein said obtaining the findings comprises receiving reports of the performing the monitoring of the controls.

38. The computer program product of claim 29, wherein the monitoring of the controls is performed automatically by a computer, and wherein said obtaining the findings comprises receiving the findings in a computer-readable format.

39. The computer program product of claim 29, wherein the potential event is selected from a group consisting of: a goal, an aim, a risk, an opportunity, a desired state, an undesired state, a desired event and an undesired event.

40. The computer program product of claim 29, wherein the processor is further adapted to perform:
obtaining scheduling specifications defining scheduling of control monitoring, wherein a scheduling specification defines a time on which controls should be monitored;
identifying a missed monitoring of a control based on the scheduling specification and the findings; and
notifying the user of the missed monitoring of the control.

41. The computer program product of claim 29, wherein said control specification further defines for each potential finding an evaluated quality score, wherein evaluated quality score comprises an assessment of a performance resulting in an occurrence of the potential finding.

42. The computer program product of claim 29, wherein the processor is further adapted to perform:
computing an aggregated quality score,
wherein said computing the aggregated quality score comprises:
obtaining an aggregation criterion;
aggregating all findings falling within the aggregation criterion using an aggregation function, wherein the aggregation function is selected from the group consisting of: a minimum function, a maximum function, a weighted average function, a median function, a summation function, a summation function with a diminishing marginal effect, and a combination thereof; and
displaying the aggregated quality score to a user.
